(19) United States
(12) Patent Application Publication
(10) Pub. No.: US 2001/0008418 A1
(43) Pub. Date: Jul. 19, 2001

(54) Image processing apparatus and method

(75) Inventors: Mutsuhiro Yamanaka, Osaka (JP); Hironori Sumitomo, Osaka (JP); Yuusuke Nakano, Akashi-Shi (JP)

Correspondence Address: Michael E. Fogarty, McDERMOTT, WILL & EMERY, 600 13th Street, N.W., Washington, DC, 20005-3096, US

(73) Assignee: Minolta Co., Ltd.

(21) Appl. No.: 09/757,654

(22) Filed: Jan. 11, 2001

(30) Foreign Application Priority Data
Jan. 13, 2000 (JP) P2000-004711
Jan. 13, 2000 (JP) P2000-004941
Jan. 13, 2000 (JP) P2000-004942

(51) Int. Cl. H04N 5/217

(52) U.S. Cl. 348/222; 348/241; 382/254; 382/275

(57) ABSTRACT

A digital camera acquires information about an optical system such as the arrangement of lenses in image capture, an aperture value, and the like to obtain a degradation function indicating a degradation characteristic of an image relative to the optical system. An image obtained is restored by using the degradation function. An area to be restored may be a whole or part of the image. Alternatively, the area to be restored may be reset and restored again on the basis of a restored image. The degradation function can also be obtained on the basis of subject movements in a plurality of continuously captured images. This enables proper image restoration without the use of a sensor for detecting a shake of an image capturing device.

This application is based on applications Nos. 2000-4711, 2000-4941, and 2000-4942 filed in Japan, the entire contents of which are hereby incorporated by reference.

### BACKGROUND OF THE INVENTION

1. Field of the Invention

The present invention relates to image processing techniques for restoring degraded image data obtained by image capture.

2. Description of the Background Art

Conventionally, a variety of techniques have been proposed to restore a degraded image which is obtained as image data by the use of an array of light sensing elements which is typified by a CCD. Image degradation refers to degradation of an actually obtained image as compared with the ideal image which was supposed to be obtained from a subject. For example, an image captured by a digital camera suffers degradation from aberrations depending on an aperture value, a focal length, an in-focus lens position, and the like and from an optical low-pass filter provided for the prevention of spurious resolution.

Such a degraded image has conventionally been restored by modeling of image degradation for bringing the image close to the ideal image. Assuming for example that image degradation has come from the spread of incoming luminous fluxes according to a Gaussian distribution, the fluxes being supposed to enter each of the light sensing elements, image restoration is made by the application of a restoration function to the image or by the use of a filter (a so-called aperture compensation filter) for edge enhancement of the image.

The conventional image restoration techniques, however, take no account of actual causes of image degradation. Thus, it is frequently difficult to obtain an ideal image through the restoration.

Further, image degradation will not always occur in the whole image. For example when taking a subject with a geometrical pattern or a single-color background or when scanning a document for character recognition, an area that is not affected by degradation exists in an image. From this, restoration processing on the whole image can have an adverse effect on an area that does not require the restoration processing. For example, restoration processing on areas with edge or noise can cause ringing or noise enhancement, having an adverse effect on areas that do not require restoration.

On the other hand, an image capturing apparatus such as a digital camera may not be able to obtain ideal images because of its shake in image capture. Techniques for compensating for such image degradation due to shakes include a technique for correcting the obtained image with a shake sensor such as an acceleration sensor, and a technique for estimating shakes from a single image.

The above conventional techniques, however, have problems: for example, the former requires a special shake sensor and the latter has low precision in shake estimation.

### SUMMARY OF THE INVENTION

An object of the present invention is to restore degraded images properly.

The present invention is directed to an image processing apparatus.

According to one aspect of the present invention, the image processing apparatus comprises: an obtaining section for obtaining image data generated by converting an optical image passing through an optical system into digital data; and a processing section for applying a degradation function based on a degradation characteristic of at least one optical element comprised in the optical system to the image data and restoring the image data by compensating for a degradation thereof. With the degradation function, image data can be restored properly according to the optical system.

According to another aspect of the present invention, the image processing apparatus comprises: a receiving section for receiving a plurality of image data sets generated by two or more consecutive image captures; a calculating section for calculating a degradation function on the basis of a difference between the plurality of image data sets; and a restoring section for restoring one of the plurality of image data sets by applying the degradation function. Thereby, one of the plurality of image data sets can be restored properly.

According to still another aspect of the present invention, the image processing apparatus comprises: a setting section for setting partial areas in a whole image, the partial areas being delimited according to contrast in the whole image; and a modulating section for modulating images comprised in the partial areas on the basis of a degradation characteristic of the whole image to restore the whole image. Thus, the partial areas to be restored can be determined properly according to contrast in the whole image. Alternatively, the partial areas may be determined on the basis of at least one degradation characteristic of the whole image or pixel values in the whole image.

According to still another aspect of the present invention, the image processing apparatus comprises: a setting section for setting areas to be modulated in a whole image; a restoring section for restoring the whole image by modulating images in the areas in accordance with a specified function; and an altering section for altering sizes of the areas in accordance with a restored whole image, wherein the restoring section again restores the whole image by modulating images in the areas whose sizes are altered by the altering section in accordance with the specified function. The alteration of the sizes of the areas to be restored enables more proper restoration of the whole image.

This invention is also directed to an image pick-up apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a digital camera according to a first preferred embodiment;

FIG. 2 is a rear view of the digital camera;

FIG. 3 is a side view of the digital camera;

FIG. 4 is a longitudinal cross-sectional view of a lens unit and its vicinity;

FIG. 5 is a block diagram of a construction of the digital camera;

FIGS. 6 to 9 are explanatory diagrams of image degradation due to the lens unit;

FIGS. 10 and 11 are explanatory diagrams of image degradation due to an optical low-pass filter;

FIG. 12 is a flow chart of processing of a first image restoration method;

FIG. 13 is a flow chart of processing of a second image restoration method;

FIG. 14 is a flow chart of processing of a third image restoration method;

FIG. 15 is a flow chart of the operation of the digital camera in image capture;

FIG. 16 is a block diagram of functional components of the digital camera;

FIG. 17 shows an example of an acquired image;

FIG. 18 shows an example of restoration areas;

FIG. 19 is a flow chart of restoration processing according to the second preferred embodiment;

FIG. 20 is a block diagram of functional components of the digital camera;

FIG. 21 is a flow chart of restoration processing according to a third preferred embodiment;

FIG. 22 is a block diagram of part of functional components of a digital camera according to the third preferred embodiment;

FIG. 23 shows an example of the acquired image;

FIGS. 24 and 25 show examples of a restored image;

FIG. 26 is an explanatory diagram of image degradation due to camera shake;

FIG. 27 is a flow chart of restoration processing according to a fourth preferred embodiment;

FIG. 28 is a block diagram of part of functional components of a digital camera according to the fourth preferred embodiment;

FIG. 29 shows an example of the restoration areas;

FIG. 30 is a flow chart of restoration processing according to a fifth preferred embodiment;

FIG. 31 shows a whole configuration according to a sixth preferred embodiment;

FIG. 32 is a schematic diagram of a data structure in a memory card;

FIG. 33 is a flow chart of the operation of the digital camera in image capture;

FIG. 34 is a flow chart of the operation of a computer;

FIG. 35 is a block diagram of functional components of the digital camera and the computer;

FIG. 36 is a block diagram of functional components of the digital camera 1;

FIG. 37 is a schematic diagram of continuously captured images SI1, SI2, and SI3 of a subject;

FIG. 38 is a schematic diagram of a track L1 that a subject image describes in the images SI1, SI2, and SI3 due to camera shake;

FIG. 39 is an enlarged view of representative points P1, P2, P3 of the subject image and their vicinity in the images SI1, SI2, SI3;

FIG. 40 shows an example of a two-dimensional filter (degradation function);

FIG. 41 is a flow chart of process operations of the digital camera 1;

FIG. 42 shows representative positions B1 to B9 and areas A1 to A9;

FIG. 43 is a schematic diagram showing differences in the amount of camera shake among central and end areas;

FIG. 44 is a schematic diagram of a computer 60.

### DESCRIPTION OF THE PREFERRED EMBODIMENTS

### 1. First Preferred Embodiment

### 1-1. Construction of Digital Camera

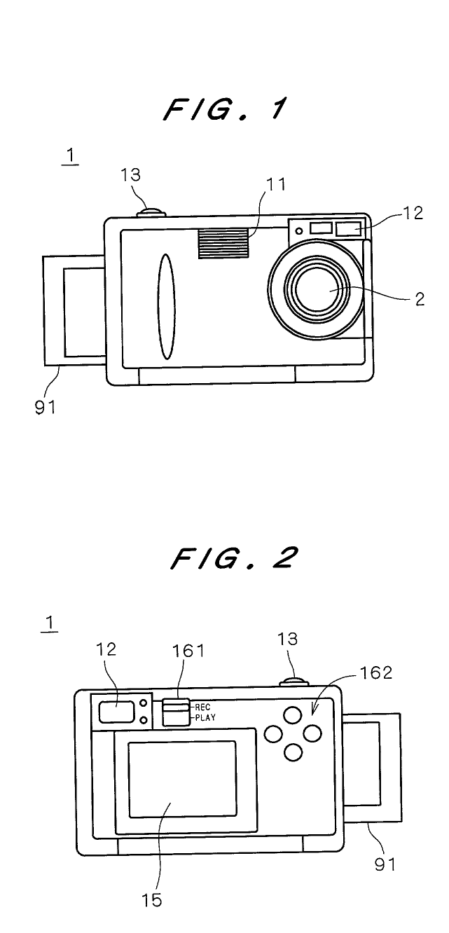

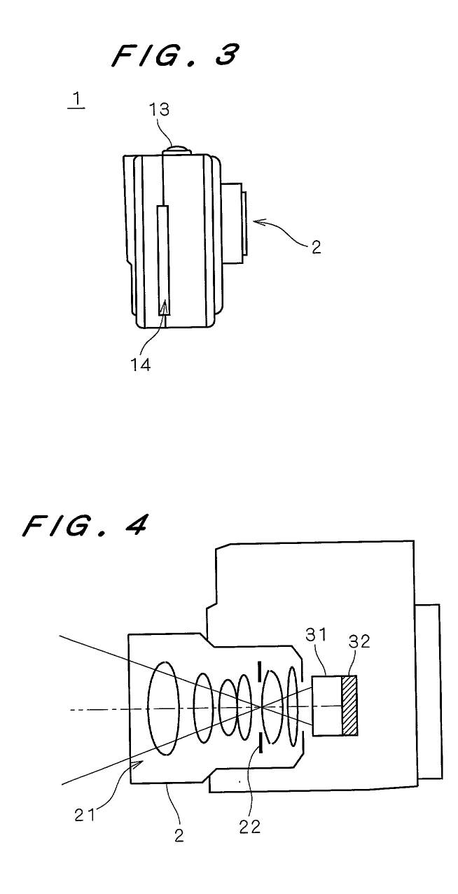

FIGS. 1 to 3 are external views of a digital camera 1 according to a first preferred embodiment of the present invention. FIG. 1 is a front view; FIG. 2 is a rear view; and FIG. 3 is a left side view. FIGS. 1 and 2 show how the digital camera 1 loads a memory card 91, which is not shown in FIG. 3.

The digital camera 1 is principally similar in construction to previously known digital cameras. As shown in FIG. 1, a lens unit 2 for conducting light from a subject to a CCD and a flash 11 for emitting flash light to a subject are located on the front, and a viewfinder 12 for capturing a subject is located above the lens unit 2.

Further, a shutter button 13 to be pressed in a shooting operation is located on the upper surface and a card slot 14 for loading the memory card 91 is provided in the left side surface.

On the back of the digital camera 1, as shown in FIG. 2, there are a liquid crystal display 15 for display of images obtained by shooting or display of operating screens, a selection switch 161 for switching between recording and playback modes, a 4-way key 162 for a user to allow selective input, and the like.

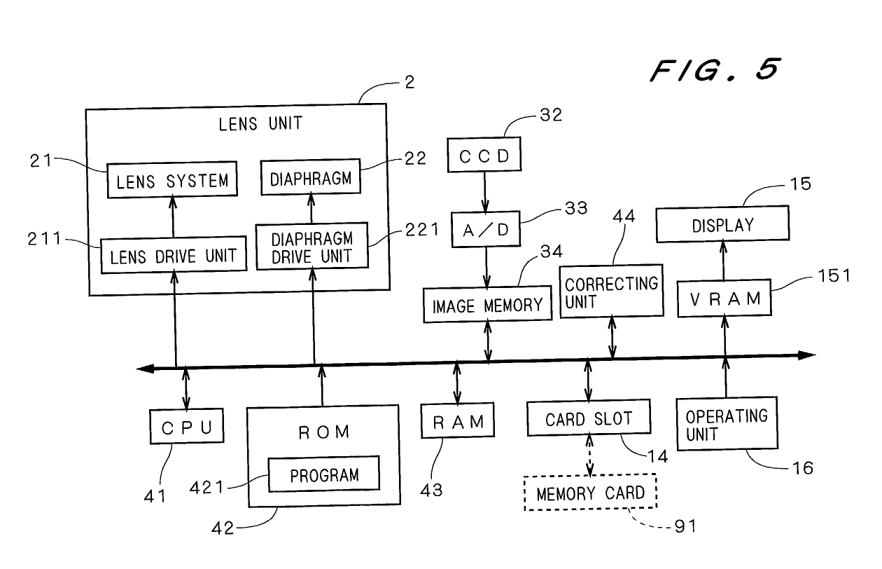

FIG. 4 is a longitudinal cross-sectional view of the internal structure of the digital camera 1 in the vicinity of the lens unit 2. The lens unit 2 has a built-in lens system 21 comprised of a plurality of lens, and a built-in diaphragm 22. Behind the lens unit 2, an optical low-pass filter 31 and a single-plate color CCD 32 with a two-dimensional array of light sensing elements are located in this order. That is, the lens system 21, the diaphragm 22, and the optical low-pass filter 31 constitute an optical system for conducting light from a subject into the CCD 32 in the digital camera 1.

FIG. 5 is a block diagram of prime components of the digital camera 1 relative to the operation thereof. In FIG. 5, the shutter button 13, the selection switch 161, and the 4-way key 162 are shown in one block as an operating unit 16.

A CPU 41, a ROM 42, and a RAM 43 shown in FIG. 5 control the overall operation of the digital camera 1, and together with the CPU 41, the ROM 42, and the RAM 43, a variety of components are connected as appropriate to a bus line. The CPU 41 performs computations according to a program 421 in the ROM 42, using the RAM 43 as a work area, whereby the operation of each unit and image processing are performed in the digital camera 1.

The lens unit 2 comprises, along with the lens system 21 and the diaphragm 22, a lens drive unit 211 and a diaphragm drive unit 221 for driving the lens system 21 and the diaphragm 22, respectively. The CPU 41 controls the lens system 21 and the diaphragm 22 as appropriate in response to output from a distance-measuring sensor and subject brightness.

The CCD 32 is connected to an A/D converter 33 and outputs a subject image, which is formed through the lens system 21, the diaphragm 22, and the optical low-pass filter 31, to the A/D converter 33 as image signals. The image signals are converted into digital signals (hereinafter referred to as “image data”) by the A/D converter 33 and stored in an image memory 34. That is, the optical system, the CCD 32, and the A/D converter 33 obtain a subject image as image data.

A correcting unit 44 performs a variety of image processing such as white balance control, gamma correction, noise removal, color correction, and color enhancement on the image data in the image memory 34. The corrected image data is transferred to a VRAM (video RAM) 151, whereby an image appears on the display 15. By the user's operation, the image data is recorded as necessary on the memory card 91 through the card slot 14.

The digital camera 1 further performs processing for restoration of degradation in the image data obtained, due to the influences of the optical system. This restoration processing is implemented by the CPU 41 performing computations according to the program 421 in the ROM 42. Substantially, image processing (correction and restoration) in the digital camera 1 is performed on the image data, but in the following description, the “image data” to be processed is simply referred to as an “image” as appropriate.

### 1-2. Image Degradation due to Optical System

Next, image degradation in the digital camera 1 is discussed. The image degradation refers to a phenomenon that images obtained through the CCD 32, the A/D converter 33, and the like in the digital camera 1 are not ideal images. Such image degradation results from a spreading distribution of a luminous flux, which comes from one point on a subject, over the CCD 32 without converging to a single point thereon. In other words, a luminous flux which is supposed to be received by a single light sensing element (i.e., a pixel) of the CCD 32 in an ideal image, spreads to neighboring light sensing elements, thereby causing image degradation.

In the digital camera 1, image degradation due to the optical system, which is primarily composed of the lens system 21, the diaphragm 22, and the optical low-pass filter 31, is restored.

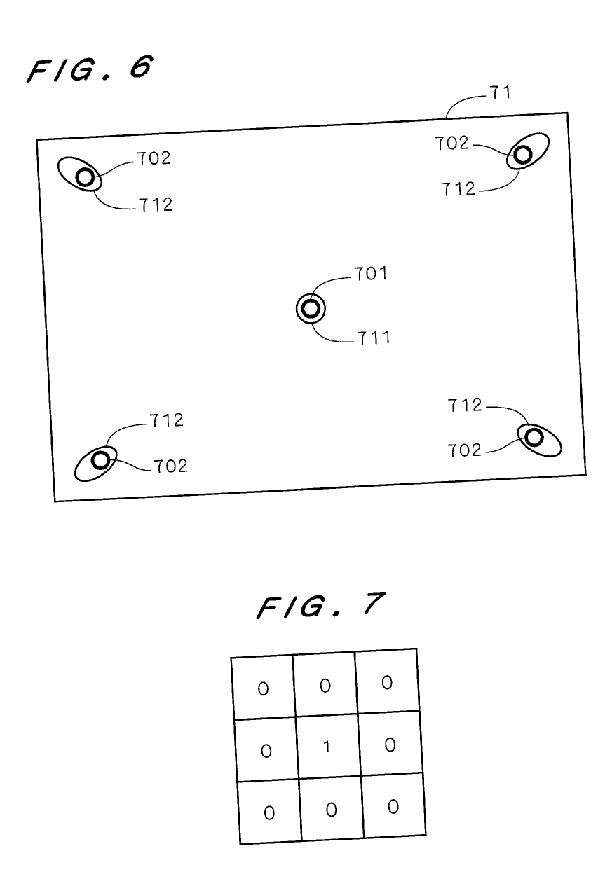

FIG. 6 is an explanatory diagram of image degradation due to the lens unit 2. The reference numeral 71 in FIG. 6 designates a whole image. If an area designated by the reference numeral 701 shall be illuminated in an image which does not suffer degradation due to the influences of the optical system (hereinafter referred to as an “ideal image”), an area 711 larger than the area 701 is illuminated in an image actually obtained (hereinafter referred to as an “acquired image”) in response to the focal length and the in-focus lens position (corresponding to the amount of travel for a zoom lens) in the lens system 21 and the aperture value of the diaphragm 22. That is, a luminous flux which should ideally enter the area 701 of the CCD 32 spreads across the area 711 in practice.

The same can be said of the periphery of the image 71. If an area designated by the reference numeral 702 shall be illuminated in the ideal image, a generally elliptical area enlarged as designated by the reference numeral 712 is illuminated in the acquired image.

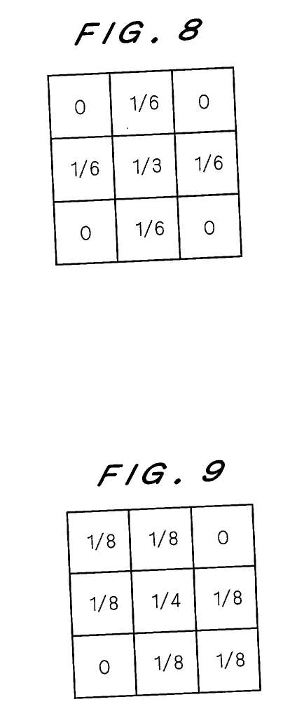

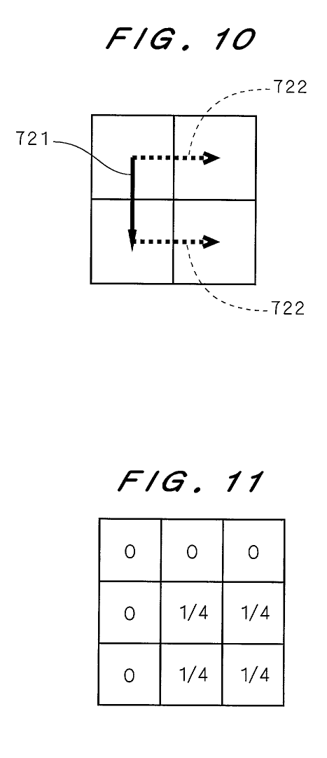

FIGS. 7 to 9 are schematic diagrams for explaining image degradation due to the optical influence of the lens unit 2 at the level of light sensing elements. FIG. 7 shows that without the influence of the lens unit 2 (i.e., in the ideal image), a luminous flux with light intensity 1 is received by only a light sensing element in the center of 3×3 light sensing elements. FIGS. 8 and 9, on the other hand, show how the influence of the lens unit 2 changes the state shown in FIG. 7.

FIG. 8 shows, by way of example, the state near the center of the CCD 32, where light with intensity 1/3 is received by a central light sensing element while light with intensity 1/6 is received by upper/lower and right/left light sensing elements adjacent to the central light sensing element. That is, a luminous flux which is supposed to be received by the central light sensing element spreads therearound by the influence of the lens unit 2. FIG. 9 shows, by way of example, the state in the periphery of the CCD 32, where light with intensity 1/4 is received by a central light sensing element while light with intensity 1/8 is received by neighboring light sensing elements, spreading from top left to bottom right.

Such a degradation characteristic of the image can be expressed as a function (i.e., a two-dimensional filter based on point spread) that converts each pixel value in the ideal image into a distribution of pixel values as illustrated in FIGS. 8 and 9; therefore, it is called a degradation function (or degradation filter).

A degradation function indicating the degradation characteristic due to the influence of the lens unit 2 can previously be obtained for every position of a light sensing element (i.e., for every pixel location) on the basis of the focal length and the in-focus lens position in the lens system 21 and the aperture value of the diaphragm 22. From this, the digital camera 1, as will be described later, obtains information about the arrangement of lenses and the aperture value from the lens unit 2 to obtain a degradation function for each pixel location, thereby achieving a restoration of the acquired image on the basis of the degradation functions.

The degradation function relative to the lens unit 2 is generally a nonlinear function using, as its parameters, the focal length, the in-focus lens position, the aperture value, two-dimensional coordinates in the CCD 32 (i.e., 2D coordinates of pixels in the image), and the like. For convenience's sake, FIGS. 7 to 9 contain no mention of the color of the image; however for color images, a degradation function for each of R, G, B colors or a degradation function which is a summation of the degradation functions for such colors is obtained. For simplification of the process, chromatic aberration may be ignored to make degradation functions for R, G, B colors equal to each other.

FIG. 10 is a schematic diagram for explaining degradation due to the optical low-pass filter 31 at the level of light sensing elements of the CCD 32. The optical low-pass filter 31 is provided for preventing spurious resolution by setting a band limit using birefringent optical materials. For a single-plate color CCD, as shown in FIG. 10, light which is supposed to be received by the upper left light sensing element is first distributed between the upper and lower left light sensing elements as indicated by an arrow 721, and then between the upper right and left light sensing elements and between the lower right and left light sensing elements as indicated by arrows 722.

In a single-plate color CCD, two light sensing elements on the diagonal out of four light sensing elements adjacent to each other, are provided with green (G) filters and the remaining two light sensing elements are provided with red (R) and blue (B) filters, respectively. R, G, B values of each pixel are obtained by interpolation with reference to information obtained from its neighboring pixels. In the single-plate color CCD, however, there are green pixels twice as much as red or blue pixels; therefore, the use of data from the CCD without any modification results in the creation of an image whose green resolution is higher than red and blue resolutions. Accordingly, high-frequency components, which cannot be obtained with the light sensing elements provided with R or B filters, appear in a subject image as spurious resolution.

From this reason, the optical low-pass filter 31 having the property as illustrated in FIG. 10 is provided on the front of the CCD 32. However, the influence of this optical low-pass filter 31 causes degradation of high-frequency components, which are obtained with the green light sensing elements, in an image.

FIG. 11 illustrates the distribution of a luminous flux which were supposed to be received by a central light sensing element, in the presence of the optical low-pass filter 31 having the property as illustrated in FIG. 10. That is, it schematically shows the characteristic of a degradation function relative to the optical low-pass filter 31. As shown in FIG. 11, the optical low-pass filter 31 distributes a luminous flux which is supposed to be received by a central light sensing element among 2×2 light sensing elements. From this, the digital camera 1, as will be described later, prepares a degradation function relative to the optical low-pass filter 31 beforehand, thereby achieving a restoration of the acquired image on the basis of the degradation function.

In the process of restoration using the degradation function relative to the optical low-pass filter 31, a luminance component is obtained from R, G, B values of each pixel after interpolation and this luminance component is restored. As an alternative to the restoration technique described above, G components may be restored after interpolation and interpolation using restored G components may be performed for R and B components.

While in the foregoing description the degradation function is obtained for each pixel, a summation of degradation functions for a plurality of pixels or for all pixels (i.e., a transformation matrix corresponding to degradation of a plurality of pixels) may be used.

### 1-3. Image Restoration

Next, three concrete examples of restoration of the acquired image with the degradation function are mentioned. The digital camera 1 can adopt any of the following three image restoration methods.

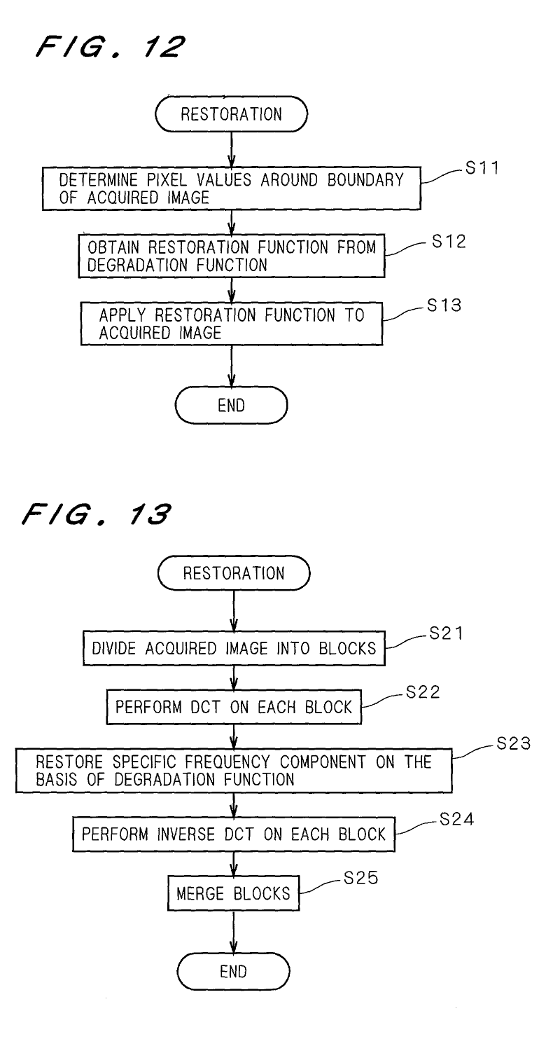

FIG. 12 is a flow chart of processing of a first image restoration method. The first image restoration method is for obtaining a restoration function from a degradation function and applying the restoration function to the acquired image for restoration.

Consider a degraded image which is obtained by applying a degradation function to each pixel in the ideal image. Since the degradation function has the function of using each pixel value to alter its neighboring pixel values, the degraded image is larger in size than the ideal image. Here, if the ideal image and the acquired image are the same in size, the degraded image from which peripheral pixels are deleted can be considered as the acquired image. Therefore, when obtaining a restoration function for inverse transformation of the degradation function, there is no information about the outside (i.e., the outer periphery) of an area to be processed and therefore a proper restoration function cannot be obtained.

In the first image restoration method, virtual pixels are first provided outside the area to be processed and pixel values of those virtual pixels are determined as appropriate (step S11). For example, pixel values on the inner side of the boundary of the acquired image are used as-is as pixel values on the outer side of the boundary. From this, it can be assumed that a vector Y which is an array of pixel values in an after-modification acquired image and a vector X which is an array of pixel values in the ideal image satisfy the following equation:

HX=Y (1)

where a matrix H is the degradation function to be applied to the whole ideal image (hereinafter referred to as an “image degradation function”) which is obtained by summation of degradation functions for all pixels.

Then, an inverse matrix H⁻¹ of the matrix H, which is an image degradation function, is obtained as a restoration function for image restoration (step S12), and the vector X is obtained from the following equation:

X=H⁻¹Y (2)

That is, the restoration function is applied to the after-modification acquired image for image restoration (step S13).

FIG. 13 is a flow chart of processing of a second image restoration method. Since the degradation function generally has the characteristic of reducing a specific frequency component in the ideal image, the second image restoration method makes a restoration of a specific frequency component in the acquired image for image restoration.

First, the acquired image is divided into blocks each consisting of a predetermined number of pixels (step S21) and a two-dimensional Fourier transform (i.e., discrete cosine transform (DCT)) is performed on each block, thereby to convert each block into frequency space (step S22).

Then, a reduced frequency component is restored on the basis of the characteristic of the degradation function (step S23). More specifically, each Fourier-transformed block is divided by a Fourier-transformed degradation function, then inversely Fourier-transformed (inverse DCT) (step S24) and those restored blocks are merged to obtain a restored image (step S25).

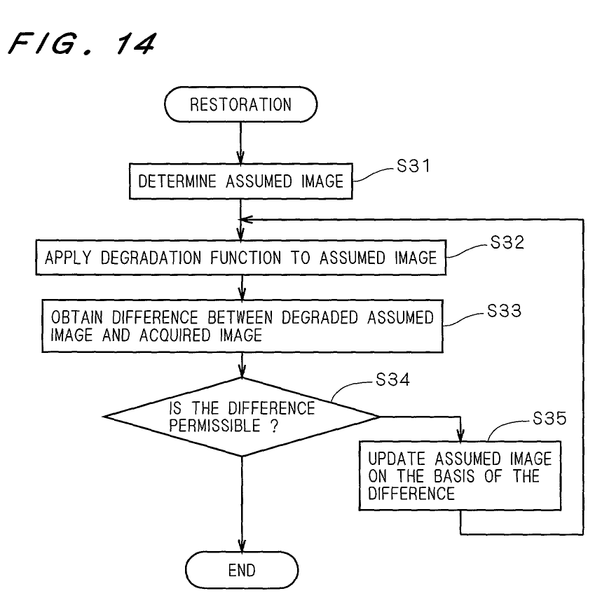

FIG. 14 is a flow chart of processing of a third image restoration method. The third image restoration method is for assuming a before-degradation image (hereinafter, the image assumed is referred to as an “assumed image”) and updating the assumed image by an iterative method, thereby to obtain a before-degradation image.

First, the acquired image is used as an initial assumed image (step S31). Then, the degradation function (precisely, the matrix or image degradation function H) is applied to the assumed image (step S32) and a difference between an image obtained and the acquired image is found (step S33). The assumed image is then updated on the basis of the difference (step S35).

More specifically, on the basis of the vector Y representing the acquired image and the vector X representing the assumed image, a vector X that satisfies the following equation with the minimum value is obtained as an after-modification assumed image:

[Y−HX]^{T}W[Y−HX] (3)

where W is the weighing matrix (or may be the unit matrix).

After that, the update of the assumed image is repeated until the difference between the acquired image and the degraded assumed image comes within permissible levels (step S34). The assumed image eventually obtained becomes a restored image.

That is, a sum of the squares of differences between each pixel value in the acquired image and a corresponding pixel value in the assumed image (or a sum of the loaded squares) is obtained as a difference between the vector Y representing the acquired image and the vector HX representing the after-degradation assumed image, and simultaneous equations of one dimension, Y=HX, is solved by the iterative method. Thereby, the vector X with the minimum difference is obtained. A more detailed description of the third image restoration method is given for example in an article entitled “RESTORATION OF A SINGLE SUPER-RESOLUTION IMAGE FROM SEVERAL BLURRED, NOISY AND UNDER-SAMPLED MEASURED IMAGES” by M. Elad and A. Feuer, IEEE Trans., On Image Processing, Vol. 6, No. 12, pp. 1646-1658, December, 1997. Of course, various other techniques can be used for the details of the iterative method.

The use of the third image restoration method enables more proper image restoration than the use of the first and second image restoration methods, but the digital camera 1 may use any of the first to third image restoration methods or it may also use any other method.

### 1-4. Operation of Digital Camera

So far, the construction of the digital camera 1, the degradation function indicating degradation of the acquired image, and the image restoration using the degradation function have been described. Next, the operation of the digital camera 1 which performs the image restoration using the degradation function is discussed.

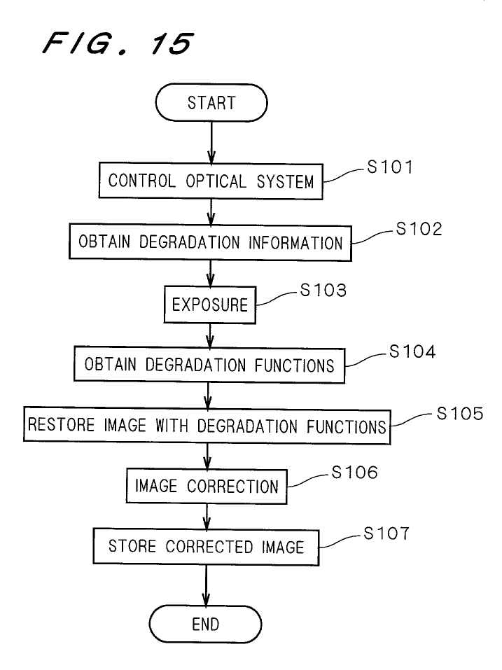

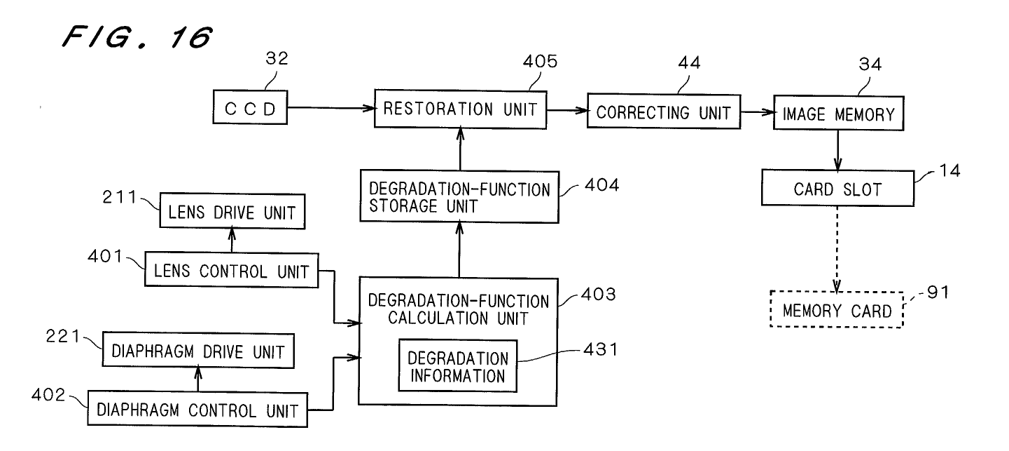

FIG. 15 is a flow chart of the operation of the digital camera 1 in image capture, and FIG. 16 is a block diagram of functional components of the digital camera 1 relative to a shooting operation thereof. In FIG. 16, a lens control unit 401, a diaphragm control unit 402, a degradation-function calculation unit 403, a degradation-function storage unit 404, and a restoration unit 405 are functions achieved by the CPU 41, the ROM 42, the RAM 43, and the like with the CPU 41 performing computations according to the program 421 in the ROM 42.

Upon the press of the shutter button 13, the digital camera 1 controls the optical system to form a subject image on the CCD 32 (step S101). More specifically, the lens control unit 401 gives a control signal to the lens drive unit 211 to control the arrangement of a plurality of lenses which constitute the lens system 21. Further, the diaphragm control unit 402 gives a control signal to the diaphragm drive unit 221 to control the diaphragm 22.

On the other hand, information about the arrangement of lenses and the aperture value are transmitted from the lens control unit 401 and the diaphragm control unit 402 to the degradation-function calculation unit 403 as degradation information 431 for obtaining a degradation function (step S102). Then, exposures are performed (step S103) and the subject image obtained with the CCD 32 and the like is stored as image data in the image memory 34. Subsequent image processing is performed on the image data stored in the image memory 34.

The degradation-function calculation unit 403 obtains a degradation function for each pixel from the degradation information 431 received from the lens control unit 401 and the diaphragm control unit 402, with consideration given to the influences of the lens system 21 and the diaphragm 22 (step S104). The degradation functions obtained are stored in the degradation-function storage unit 404. The degradation-function storage unit 404 also prepares a degradation function relative to the optical low-pass filter 31 beforehand.

Alternatively, in step S104, a degradation function may separately be obtained for each component or each characteristic of the lens unit 2 and then a degradation function considering the whole optical system may be obtained. For example, a degradation function relative to the lens system 21, a degradation function relative to the diaphragm 22, and a degradation function relative to the optical low-pass filter 31 may separately be prepared. The degradation function relative to the lens system 21 may be divided into a degradation function relative to the focal length and a degradation function relative to the in-focus lens position.

For simplification of a computation for obtaining a degradation function for each pixel, degradation functions for representative pixels may be obtained in an image and then degradation functions for the other pixels may be obtained by interpolation with the degradation functions for the representative pixels.

After the degradation functions are obtained, the restoration unit 405 performs previously described restoration processing on the acquired image (step S105). This restores degradation of the acquired image due to the influences of the optical system. More specifically, image restoration using the degradation function relative to the optical low-pass filter 31 and image restoration using the degradation function relative to the lens unit 2 are performed.

In the image restoration using the degradation function relative to the optical low-pass filter 31, a luminance component and other color components are obtained from R, G, B values of each pixel in an after-interpolation acquired image, and this luminance component is restored. The luminance component and the color components are then brought back into the R, G, B values.

In the image restoration using the degradation function relative to the lens unit 2, on the other hand, R, G, B values of each pixel in the acquired image are individually restored in consideration of color aberration. For simplification of the process, of course only the luminance component may be processed to simplify the restoration of image degradation due to the optical low-pass filter 31 and the lens unit 2.

Alternatively, image degradation due to the optical low-pass filter 31 and that due to the lens unit 2 may be restored at the same time. That is, an image may be restored after a degradation function for the whole optical system is obtained.

The restored image is then subjected to a variety of image processing such as white balance control, gamma correction, noise removal, color correction, and color enhancement in the correcting unit 44 (step S106) and image data corrected is stored in the image memory 34. The image data in the image memory 34 is further stored as appropriate into the memory card 91 through the card slot 14 (step S107).

As above described, for restoration of image degradation due to the influences of the optical system, the digital camera 1 uses the degradation functions indicating degradation characteristics due to the optical system. This enables proper restoration of the acquired image.

### 2. Second Preferred Embodiment

While the whole image is restored in the first preferred embodiment, a digital camera 1 according to a second preferred embodiment makes restoration of only predetermined restoration areas. Here, the digital camera 1 of the second preferred embodiment has the same configuration as shown in FIGS. 1 to 5 and performs the same fundamental operation as shown in FIG. 12; therefore, the same reference numerals are used as appropriate for the description thereof.

When the first image restoration method shown in FIG. 12 restores only restoration areas, pixel values only in the restoration areas are used as vectors X and Y in the above equation (2) for obtaining a restoration function which converts the vector Y into the vector X. This reduces the amount of processing below that in restoration of the whole image. Further, it is easy to obtain a proper restoration function because many pixel values around the restoration area are already known.

When the second image restoration method shown in FIG. 13 restores only restoration areas, only the restoration areas are divided into blocks for processing. This reduces the amount of processing below that in restoration of the whole image.

When the third image restoration method shown in FIG. 14 restores only restoration areas, only the restoration areas of the assumed image are updated. This improves the stability of a convergence of solutions in repeated computations on the restoration areas.

Next, as a way of determining restoration areas with the digital camera 1, a technique using contrast to determine restoration areas is discussed. Herein, the term “contrast” refers to a difference in pixel value between a pixel to be a target (hereinafter referred to as a “target pixel”) and its neighboring pixels.

Any kind of techniques can be used for obtaining the contrast of each pixel in the acquired image. For example, a sum total of pixel value differences between a target pixel and its neighboring pixels (e.g., eight adjacent pixels or 24 neighboring pixels) can be used. In another alternative, a sum total of the squares of pixel value differences between a target pixel and its neighboring pixels or a sum total of the ratios of pixel values therebetween may be used as contrast.

After the contrast of each pixel is obtained, it is compared with a predetermined threshold value and areas of pixels with higher contrast values than the threshold value are determined as restoration areas. The higher the exposure level (i.e., the brightness of the whole image) and the noise level, the higher the threshold value.

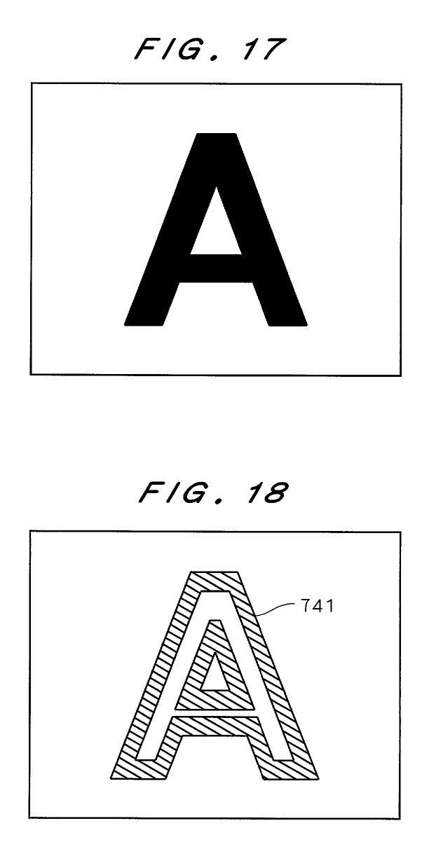

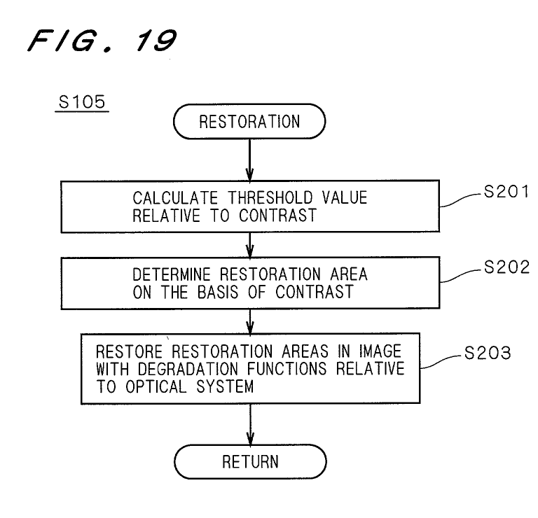

With such a technique, for example, a diagonally shaded area designated by the reference numeral 741 in FIG. 18 is determined as a restoration area of the acquired image shown in FIG. 17.

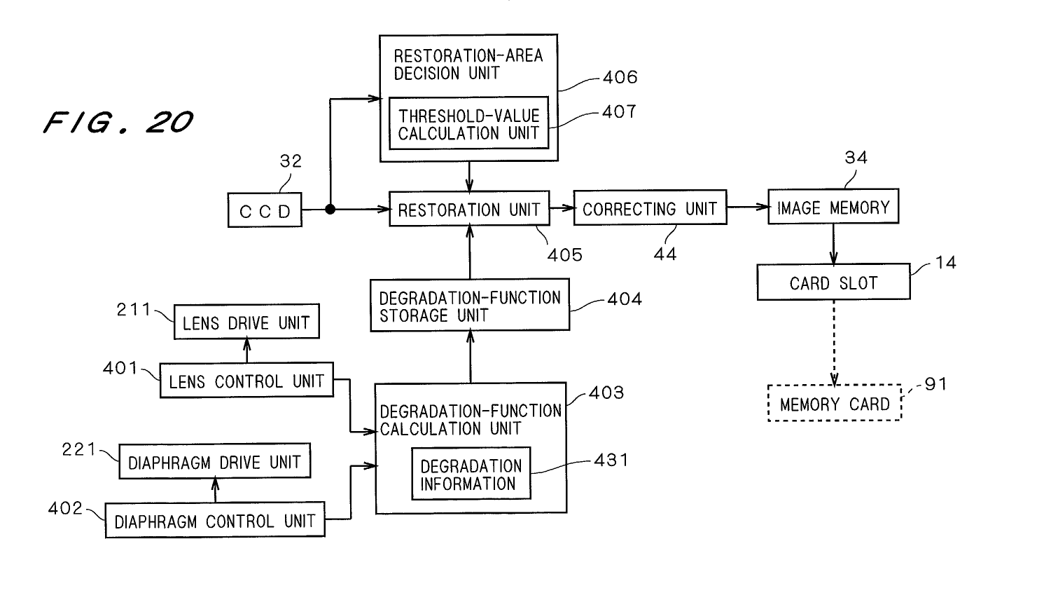

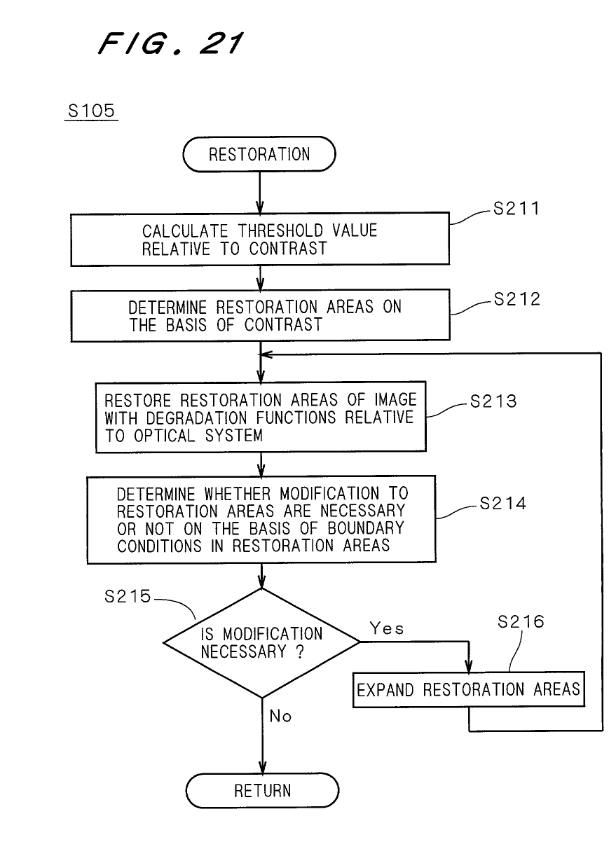

FIG. 19 is a flow chart of the operation of the digital camera 1 in image restoration, the operation corresponding to step S105 of FIG. 15. FIG. 20 is a block diagram of functional components of the digital camera 1 relative to a shooting operation thereof. The construction of FIG. 20 is such that a restoration-area decision unit 406 is added to the construction of FIG. 16. The restoration-area decision unit 406 is a function achieved by the CPU 41, the ROM 42, the RAM 43, and the like with the CPU 41 performing computations according to the program 421 in the ROM 42.

In the second preferred embodiment, after the degradation functions are obtained as in the first preferred embodiment, the restoration-area decision unit 406 determines restoration areas and the restoration unit 405 performs previously described restoration processing on the restoration areas of the acquired image (step S105). This restores degradation of only the restoration areas of the acquired image due to the influences of the optical system. More specifically, image restoration using the degradation function relative to the optical low-pass filter 31 and image restoration using the degradation function relative to the lens unit 2 are performed on the restoration areas.

In the process of image restoration, as shown in FIG. 19, a threshold-value calculation unit 407 calculates a threshold value for use in determination of the restoration areas (step S201), and the restoration-area decision unit 406 determines the restoration areas by comparing the contrast of each pixel with the threshold value (step S202). Then, image restoration is performed on the restoration areas by using any of the previously described image restoration methods, using the degradation functions relative to the optical system (step S203).

As has been described, the digital camera 1 restores image degradation of only the restoration areas due to the influences of the optical system, by the use of degradation functions which indicate degradation characteristics due to the optical system. This minimizes an adverse effect on non-degraded areas, such as the occurrence of ringing or increase of noise, thereby enabling proper restoration of the acquired image.

### 3. Third Preferred Embodiment

Now, another restoration technique that can be used for the digital camera 1 of the second preferred embodiment is discussed as a third preferred embodiment. Here, a digital camera 1 of the third preferred embodiment has the same configuration as shown in FIGS. 1 to 5 and performs the same fundamental operation as shown in FIG. 15; therefore, the same reference numerals are used as appropriate for the description thereof.

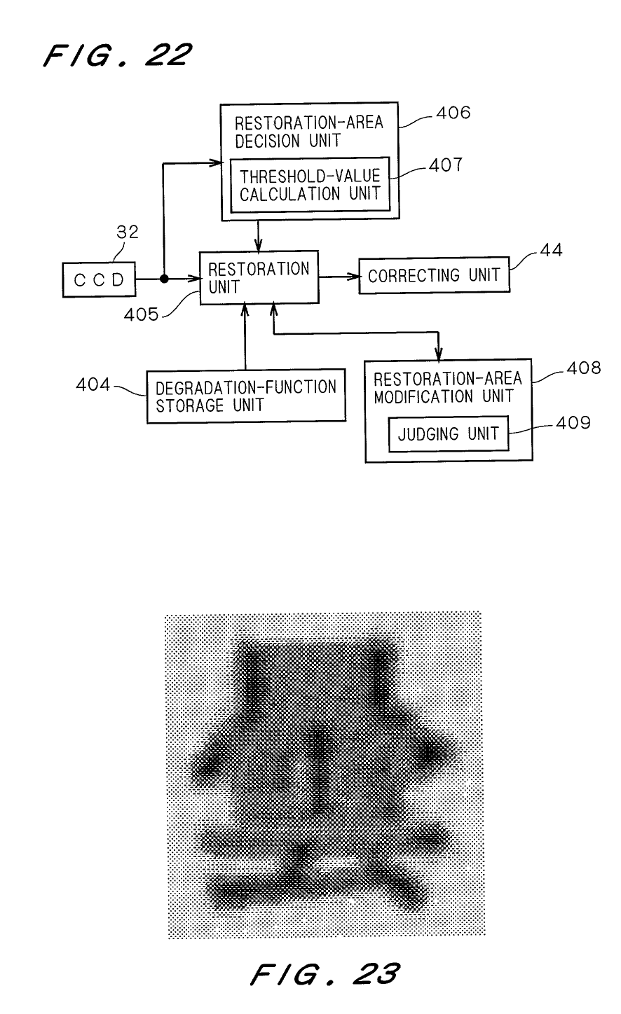

FIG. 21 shows the details of step S105 of FIG. 15 in the operation of the digital camera 1 according to the third preferred embodiment. FIG. 22 is a block diagram of functional components of the digital camera 1 around the restoration unit 405. The construction of the digital camera 1 is such that a restoration-area modification unit 408 is added to the construction of FIG. 20. The restoration-area modification unit 408 is a function achieved by the CPU 41, the ROM 42, the RAM 43, and the like, and the other functional components are similar to those in FIG. 20.

In the digital camera 1 of the third preferred embodiment, for restoration of the acquired image, the threshold-value calculation unit 407 calculates a threshold value relative to contrast from the acquired image obtained by the CCD 32 (step S211) and the restoration-area decision unit 406 determines areas of pixels with higher contrast values than the threshold value as restoration areas (step S212), both as in the second preferred embodiment. Further, the restoration unit 405 restores the restoration areas of the image by using degradation functions stored in the degradation-function storage unit 404 (step S213).

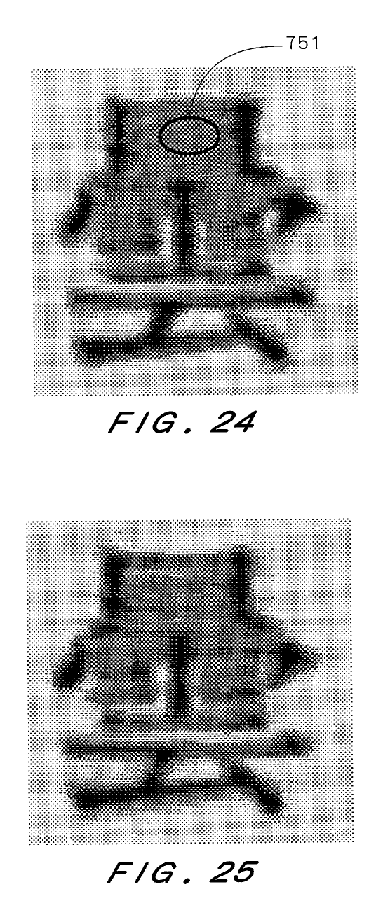

FIG. 23 shows an example of the acquired image, and FIG. 24 shows a result of image restoration using the restoration area determined by contrast. When the restoration areas are determined by contrast, an area that has completely lost its shape has low contrast and is thus not included in the restoration areas. That is, the degradation functions, which have the property of erasing or decreasing a specific frequency component, can cause for example an area which should have a stripped pattern in the ideal image to have almost no contrast in the acquired image. In FIG. 24, the reference numeral 751 designates such an area that was supposed to be restored but not restored because it was judged as a non-restoration area.

In the presence of such an area that was supposed to be restored but not restored, a restoration area which is located in contact with that area will generally have widely varying pixel values with respect to a direction along the boundary therebetween. The digital camera 1 therefore checks on the conditions of pixel values (i.e., variations in pixel values) around non-restoration areas of the restored image, and when there are variations in pixel values on the outer periphery of any non-restoration area, a judging unit 409 judges that the restoration area is in need of modification (or the size of the restoration area needs to be altered) (step S214).

Whether a non-restoration area is an area to be restored or not may be determined by focusing attention on a divergence of pixel values near the boundary of the adjacent restoration areas during restoration processing using the iterative method.

When the restoration areas are in need of modification (step S215), the restoration-area modification unit 408 makes a modification to reduce the non-restoration area concerned, i.e., to expand the restoration areas (step S216). Then, the restoration unit 405 performs restoration processing again on the modified restoration areas (step S213). The process then returns to the decision step (i.e., step S214). Thereafter, the modification to the restoration areas and the restoration processing are repeated as required (steps S213-S216). FIG. 25 shows a result of image restoration performed with modifications to the restoration areas, wherein proper restoration is made on the area 751 shown in FIG. 24.

Here, the restoration processing after the expansion of the restoration areas may be performed either on an image after previous restoration processing or an initial image (i.e., the acquired image).

As above described, the restoration areas are modified or expanded according to the conditions near the boundaries of non-restoration areas, whereby non-restoration areas that are supposed to be restored can be eliminated. This enables proper image restoration. The restored image is subjected to image correction in the correcting unit 44 and stored in the image memory 34 as in the first preferred embodiment.

### 4. Fourth Preferred Embodiment

While the techniques for restoring image degradation due to the optical system have been described in the first to third preferred embodiments, this fourth preferred embodiment provides, as a way of restoring image degradation due to other causes, a digital camera 1 that restores image degradation due to camera shake in image capture. The fundamental construction of this digital camera 1 is nearly identical to that of FIGS. 1 to 5. Although only correction for camera shake will be discussed in the fourth preferred embodiment, the restoration of image degradation due to the optical system may of course be performed at the same time.

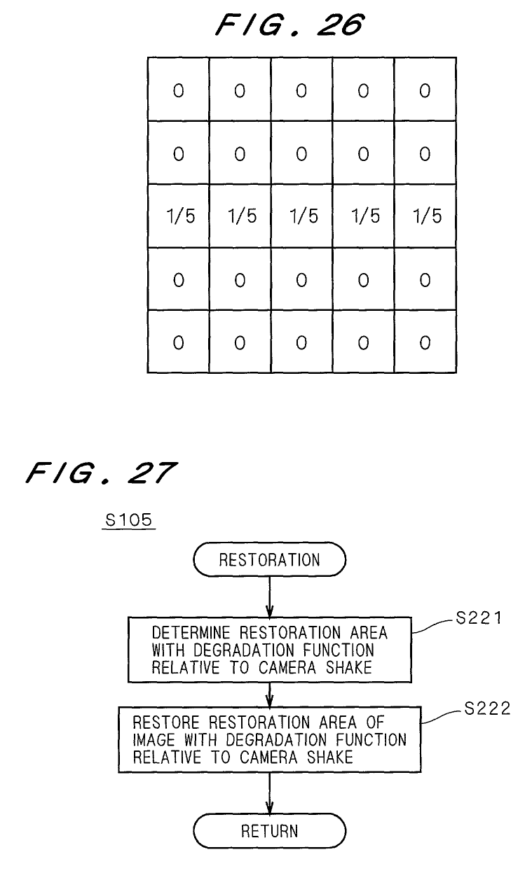

FIG. 26 is an explanatory diagram of image degradation due to camera shake. FIG. 26 shows 5×5 light sensing elements on the CCD 32, illustrating that a light flux with intensity 1, which was supposed to be received by the leftmost light sensing element in the middle row, spreads to the right because of camera shake, i.e., spreads over light sensing elements in the middle row from left to right with intensity 1/5. In other words, a degradation function for a point image which has a distribution due to degradation is shown.

The digital camera 1 of the fourth preferred embodiment is configured to be able to obtain a degradation function relative to camera shake with a displacement sensor and make proper restoration of the acquired image by using the degradation function.

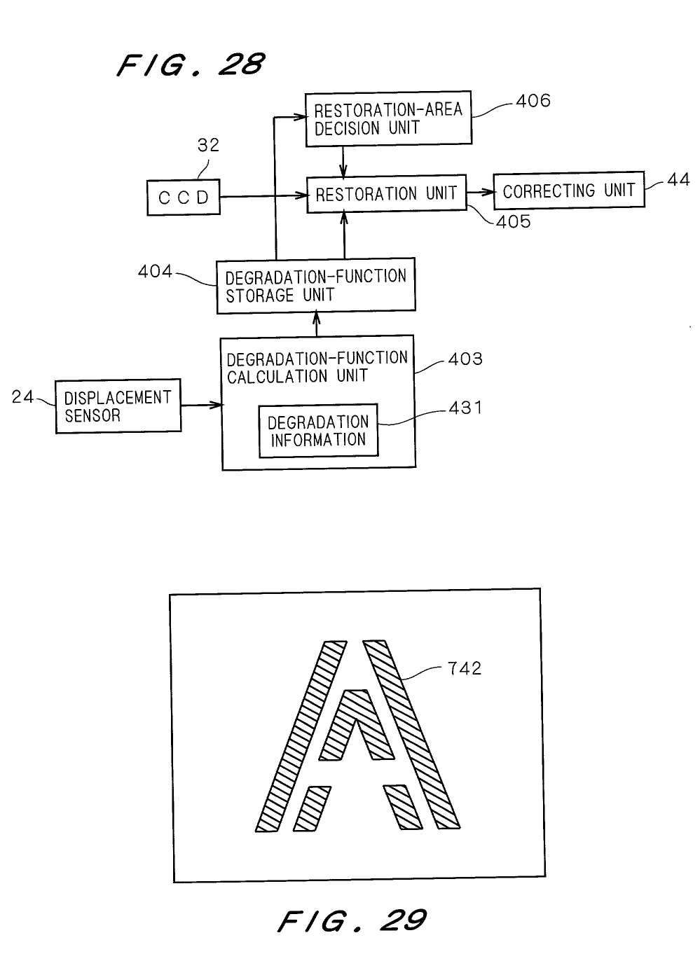

FIG. 27 shows the details of step S105 in the overall operation of the digital camera 1 shown in FIG. 15, and FIG. 28 is a block diagram of functional components around the restoration unit 405. The digital camera 1 of the fourth preferred embodiment differs from that of the second preferred embodiment (FIG. 20) in that it comprises a displacement sensor 24 for sensing the direction and amount of camera shake (i.e., a sensor for obtaining displacement with an acceleration sensor) and in that the degradation function is also transferred from the degradation-function storage unit 404 to the restoration-area decision unit 406. The other functional components are identical to those of the second preferred embodiment.

In the fourth preferred embodiment, the digital camera 1 controls the optical system for image capture as shown in FIG. 15 (steps S101, S103). At this time, information from the displacement sensor 24 is transmitted to the degradation-function calculation unit 403 as the degradation information 431 which indicates degradation of the acquired image (step S102). Then, the degradation-function calculation unit 403 calculates a degradation function having the property as illustrated in FIG. 26 on the basis of the degradation information 431 (step S104) and transfers the same to the degradation-function storage unit 404.

Following this, the determination of restoration areas and the restoration of the acquired image are performed (step S105). More specifically, as shown in FIG. 27, the restoration-area decision unit 406 determines restoration areas on the basis of the degradation function relative to camera shake which was received from the degradation-function storage unit 404 (step S221) and the restoration unit 405 restores the restoration areas of the image by using this degradation function (step S222).

In the acquired image which suffers degradation having the degradation characteristic illustrated in FIG. 26, when there are no variations in pixel values in the ideal image with respect to horizontal directions, no degradation will occur even if there are variations in pixel values in the ideal image with respect to vertical directions. For example, with the degradation function having the degradation characteristic of FIG. 26, no image degradation will occur when a horizontally extending straight line is captured. In this case, the restoration-area decision unit 406 determines, as a restoration area, only an area of pixels with higher contrast values than a predetermined threshold value with respect to the vertical directions (i.e., the direction of camera shake) on the basis of the degradation function.

In this way of determining the restoration areas on the basis of the degradation function, a diagonally shaded area 742 in FIG. 29 for example is determined as a restoration area of the acquired image shown in FIG. 17.

After the determination of the restoration areas and the restoration of the acquired image are completed, image correction is performed as in the first preferred embodiment (step S106), and the corrected image is transferred as appropriate from the image memory 34 to the memory card 91.

As previously described, the determination of the restoration areas may be performed on the basis of the degradation function (e.g., by deriving a predetermined arithmetic expression from the degradation function). Further, the degradation function relative to camera shake in the above description may be any other degradation function. For example, by referring to a frequency characteristic of the degradation function, an areas that have lost a predetermined frequency component or areas with a so-called “double-line effect” may be determined as restoration areas. Further, the restoration areas may be modified as in the second preferred embodiment.

### 5. Fifth Preferred Embodiment

Next, another technique for determining restoration areas that can be used in the second preferred embodiment is described as a fifth preferred embodiment. The construction and fundamental operation of the digital camera 1 are identical to those of FIGS. 1 to 5, 15, and 20; therefore, the same reference numerals are used for the description thereof. The digital camera 1 according to the fifth preferred embodiment can also be used for restoration of image degradation due to a variety of causes other than the optical system.

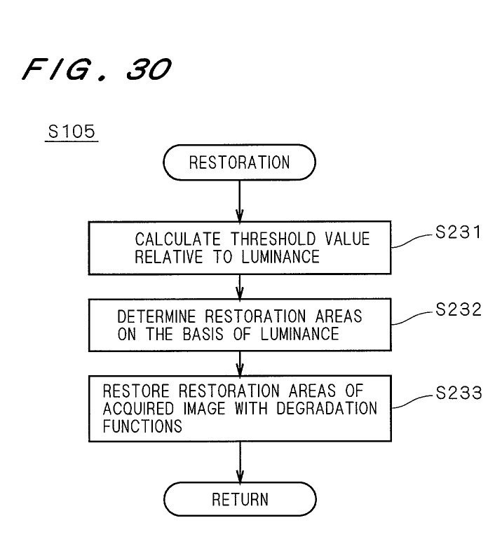

FIG. 30 is a flow chart of restoration processing (step S105 of FIG. 15) according to the fifth preferred embodiment. In the fifth preferred embodiment, the restoration areas are determined on the basis of luminance. More specifically, a predetermined threshold value is calculated on the basis of brightness of the acquired image (step S231) and areas with luminance of the predetermined threshold value or less are determined as restoration areas (step S232).

Then, as in the second preferred embodiment, restoration processing is performed on the restoration areas by using the degradation functions relative to the optical system (step S233).

As above described, the fifth preferred embodiment performs the determination of restoration areas on the basis of luminance. From this, for example a white background in an image can certainly be determined as a non-restoration area. This properly prevents the occurrence of ringing around a main subject and noise enhancement in the background during restoration processing on the whole image.

The above description is specifically given with the digital camera. For a scanner which obtains a character image for character recognition, proper character recognition can be achieved.

While in the above description an area with luminance of a predetermined threshold value or less is determined as a restoration area, an area with luminance of a predetermined threshold value or more may of course be determined as a restoration area depending on background brightness. Further, when the background brightness is already known, an area with luminance within a prescribed range may be determined as a restoration area.

When the background takes on a predetermined color as in an identification photograph, an area with color within a prescribed range may be determined as a restoration area. In this fashion, the use of pixel values (including luminance) in determining restoration areas allows proper determination, thereby enabling proper image restoration.

Also in this fifth preferred embodiment, the restoration areas may be modified as in the third preferred embodiment.

### 6. Sixth Preferred Embodiment

FIG. 31 illustrates a sixth preferred embodiment. While image restoration is performed in the digital camera 1 in the first to fifth preferred embodiments, it is performed in a computer 5 in this sixth preferred embodiment. That is, data transfer between the digital camera 1 with no image restoration capability and the computer 5 is made possible by the use of the memory card 91 or a communication cable 92, whereby images obtained by the digital camera 1 are restored in the computer 5.

Restoration processing by the computer 5 may be any restoration processing described in the first to fifth preferred embodiments, but in the following description, restoration of image degradation due to the optical system and modifications to the restoration areas are performed as in the third preferred embodiment.

The digital camera 1 of the sixth preferred embodiment is identical to that of the first preferred embodiment (i.e., the third preferred embodiment) except that it does not perform image restoration. In the following description, therefore, like or corresponding parts are denoted by the same reference numerals as in the first preferred embodiment. Further, data from the digital camera 1 may be outputted through any desired output device such as the card slot 14 or an output terminal, but in the following description, the memory card 91 is used for data transfer from the digital camera 1 to the computer 5.

The computer 5 comes preinstalled with a program for restoration processing through a recording medium 8 such as a magnetic disk, an optical disk, and a magneto-optic disk. In the computer 5, the CPU performs processing according to the program using a RAM as a work area, whereby image restoration is performed in the computer 5.

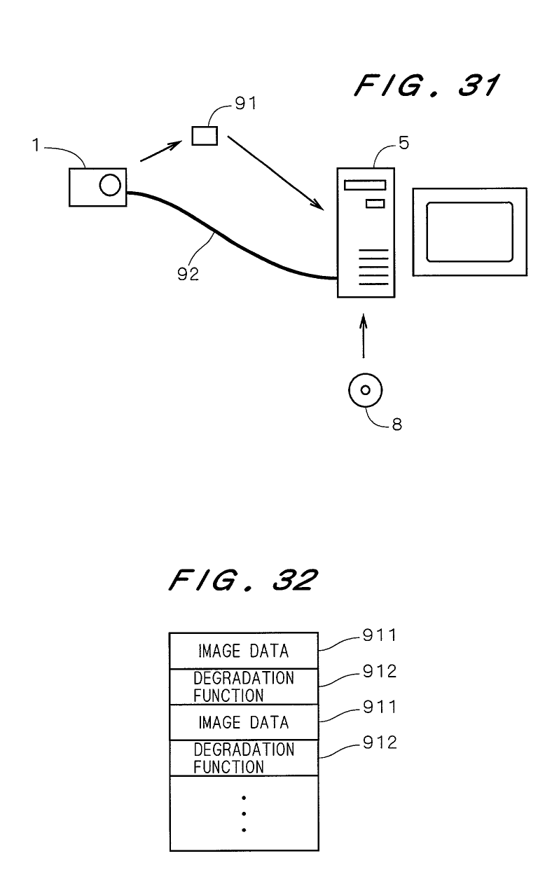

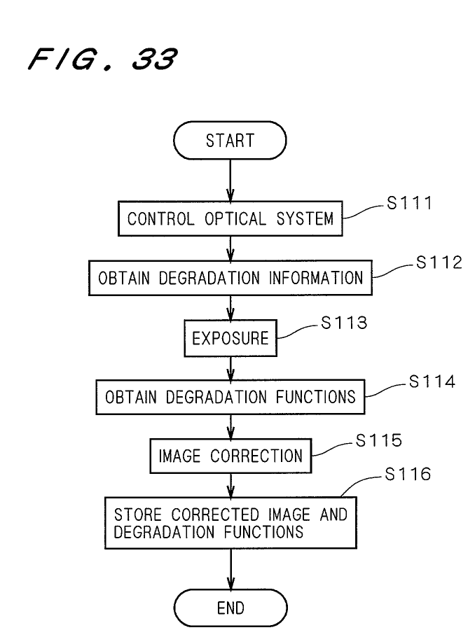

FIG. 32 is a schematic diagram of recorded-data structures in the memory card 91. The digital camera 1 captures an image as image data in the same manner as the previously-described digital cameras 1, and at the same time, obtains (or previously has stored) degradation functions indicating degradation characteristics that the optical system gives to the image. Such image data 911 and degradation functions 912 are outputted in combination to the memory card 91.

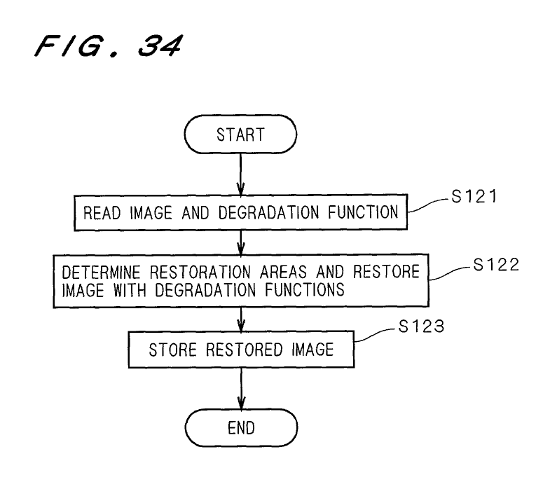

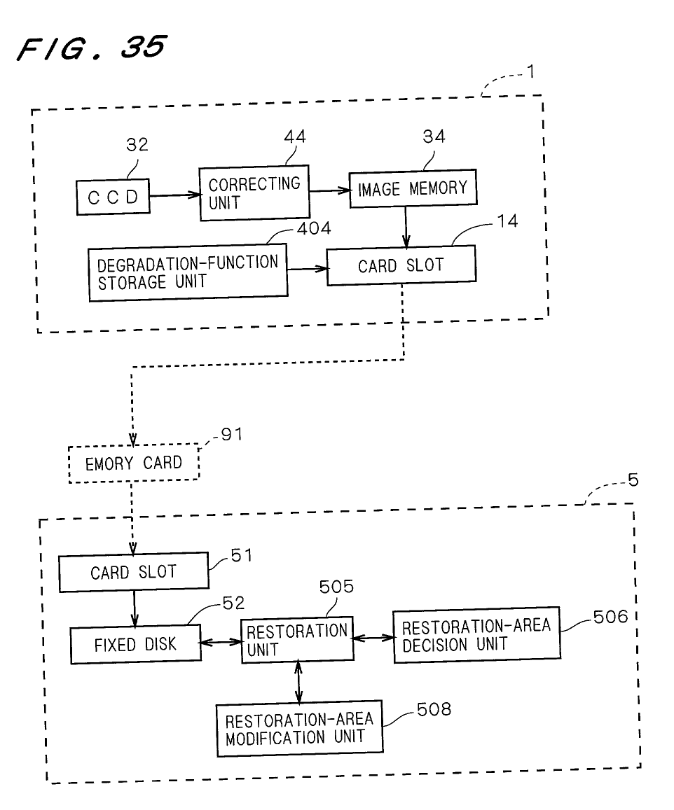

FIG. 33 is a flow chart of the operation of the digital camera 1 according to the sixth preferred embodiment in image capture, and FIG. 34 is a flow chart of the operation of the computer 5. FIG. 35 is a block diagram of functional components of the digital camera 1 and the computer 5 relative to restoration processing. In FIG. 35, only part of the functional components is shown: function components of the digital camera 1 for use in recording image data and degradation functions on the memory card 91; and functional components of the computer 5 including a card slot 51 for reading out data from the memory card 91, a fixed disk 52, a restoration unit 505, a restoration-area decision unit 506, and a restoration-area modification unit 508, the units 505, 506, 508 being achieved by the CPU, the RAM, and the like. Referring now to FIGS. 33 to 35, the operations of the digital camera 1 and the computer 5 of the sixth preferred embodiment are discussed.

In image capture by the digital camera 1, the lens control unit 401 and the diaphragm control unit 402 exercise control over the optical system (step S111 of FIG. 33) and information about the optical system is obtained as the degradation information 431 (step S112), both as in the second preferred embodiment (cf. FIG. 20). Then, exposure is performed on the CCD 32 (step S113), whereby a captured image is obtained as image data.

The degradation-function calculation unit 403 obtains a degradation function on the basis of the degradation information 431 about the lens unit 2 (step S114) and transfers the same to the degradation-function storage unit 404. As in the second preferred embodiment, the degradation-function storage unit 404 has previously stored the degradation function relative to the optical low-pass filter 31. On the other hand, the image obtained is subjected to image correction in the correcting unit 44 and stored in the image memory 34 (more correctly, image correction is made on the image data in the image memory 34) (step S115).

The digital camera 1 then, as shown in FIG. 35, outputs the image data corresponding to a corrected image and the degradation functions to the memory card 91 through the card slot 14 (step S116).

After the image data and the degradation functions are stored in the memory card 91, the memory card 91 is loaded in the card slot 51 of the computer 5. The computer 5 then reads the image data and the degradation functions into the fixed disk 52 thereby to prepare necessary data for restoration processing (step S121 of FIG. 34).

Then, the restoration-area decision unit 506 determines restoration areas on the basis of the image described by the image data, and the restoration unit 505 and the restoration-area modification unit 508 repeat previously described restoration processing using the degradation functions and modifications to the restoration areas, respectively (step S122). These operations are similar to those in the restoration processing of the third preferred embodiment shown in FIG. 21.

After the completion of image restoration, the restored image is stored in the fixed disk 52 (step S123).

As above described, the digital camera 1 of the sixth preferred embodiment outputs the image data and the degradation functions to the outside, and the computer 5 performs the determination of the restoration areas and the restoration processing using the degradation functions. That is, the digital camera 1 does not have to perform restoration processing. This accelerates time between the start of image capture and the storage of image data as compared with that in the third preferred embodiment (especially when an image captured has a large number of pixels).

### 7. Modifications to First to Sixth Preferred Embodiments

In the aforementioned preferred embodiments, images obtained by the digital camera 1 are restored. However, it is to be understood that the preferred embodiments are not limited thereto and various modifications may be made therein.

For example, while the aforementioned preferred embodiments give descriptions of degradation functions including the degradation function relative to the lens unit 2, the degradation function relative to the optical low-pass filter 31, and the degradation function relative to camera shake, any other kind of degradation functions may be obtained (or may be prepared beforehand). Further, as in the case of a 3 CCD digital camera 1 that uses only the degradation function relative to the lens unit 2 or the degradation function relative to the diaphragm 22, only a specific kind of degradation may be restored by the use of only one kind of degradation function.

As previously described, there is no need to obtain degradation functions for all pixels. For example, after obtaining degradation functions for representative pixels (i.e., light sensing elements) by using an LUT or the like, degradation functions for the other pixels may be obtained by interpolation. When degradation functions for all pixels are constant like the degradation function relative to the optical low-pass filter 31, it is sufficient to prepare only one degradation function in the ROM 42 beforehand.

That is, the use of at least one degradation function of at least one kind enables proper restoration of a specific kind of degradation.

In the aforementioned preferred embodiments, the calculation of degradation functions and image restoration are performed by the CPU, the ROM, and the RAM in the digital camera 1 or in the computer 5. Here all or part of the following components may be constructed by a purpose-built electric circuit: the lens control unit 401, the diaphragm control unit 402, the degradation-function calculation unit 403, the restoration unit 405, the restoration-area decision unit 406, and the restoration-area modification unit 408, all in the digital camera 1; and the restoration unit 505, the restoration-area decision unit 506, and the restoration-area modification unit 508, all in the computer 5.

The program 421 for image restoration by the digital camera 1 may previously be installed in the digital camera 1 through a recording medium such as the memory card 91.

Further, the preferred embodiments are not limited to restoration of images obtained by the digital camera 1 but may also be used for restoration of images obtained by any other image capturing device, such as an electron microscope or a film scanner, which uses an array of light sensing elements to obtain images. Of course, the array of light sensing elements is not limited to a two-dimensional array but may be a one-dimensional array.

The techniques for determining or modifying restoration areas are also not limited to those described in the above preferred embodiments, but a variety of techniques may be adopted. For example, restoration areas may be determined on the basis of a distribution of or variations in space frequency in the acquired image, or a non-restoration area which is surrounded by the restoration areas may be forcefully changed to a restoration area.

Further, two kinds of threshold values may be obtained for determination of restoration areas. In this case, after an image is divided into three kinds of areas, namely restoration areas, half-restoration areas, and non-restoration areas, by the use of the two threshold values, pixels in the half-restoration areas are updated to an average of before- and after-restoration pixel values (or to a weighted average). This erases clearly defined boundaries between the restoration areas and non-restoration areas.

### 8. Seventh Preferred Embodiment

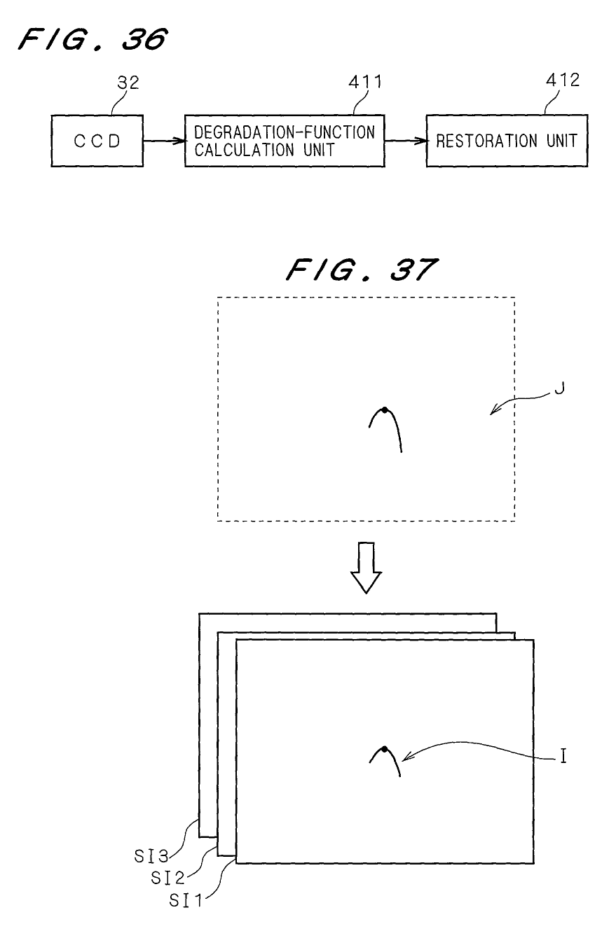

A digital camera 1 according to a seventh preferred embodiment has the same configuration as shown in FIGS. 1 to 5 and performs the same fundamental operation as shown in FIG. 15. FIG. 36 shows main functional components of the digital camera 1. A degradation-function calculation unit 411 and a restoration unit 412 are functions achieved by the CPU 41 and the like performing a program recorded on the ROM 42.

The degradation-function calculation unit 411, when focusing attention on a target image which is included in a plurality of images continuously captured by the CCD 32, obtains from the plurality of images a track of a subject image in the target image, which is caused by a shake of the digital camera 1 in image capture. Thereby, at least one degradation function indicating a degradation characteristic of the target image due to camera shake is obtained.

The restoration unit 412 restores the target image, using at least one degradation function obtained by the above degradation-function calculation unit 411.

The concrete operations of the degradation-function calculation unit 411 and the restoration unit 412 will be described later.

Referring now to FIGS. 37 to 40, the principle of image restoration is discussed. FIG. 37 shows a plurality of images (three images) SI1, SI2, and SI3 continuously captured for a predetermined subject J. The following description gives the case where restoration processing is performed on the image SI2, i.e., the image SI2 is a target image of restoration processing.

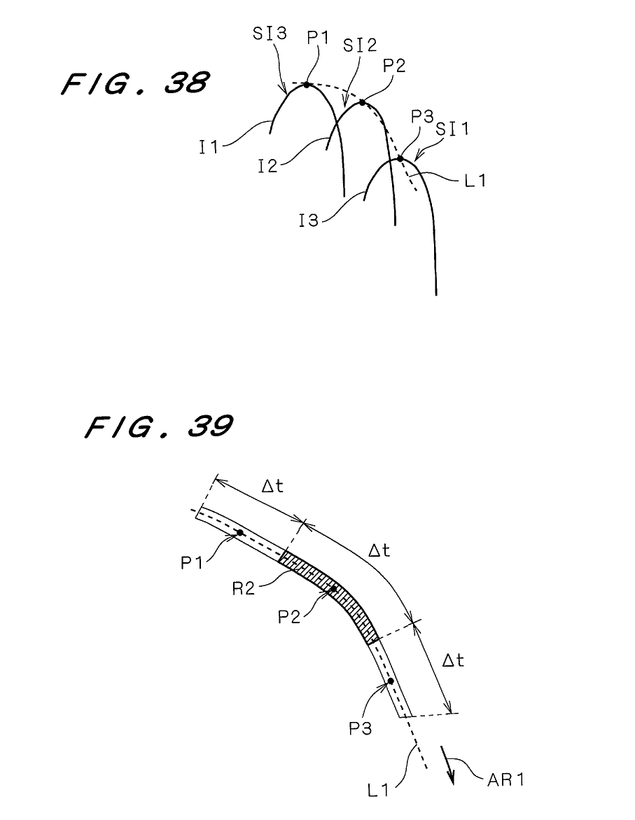

FIGS. 37 and 38 show that an image (subject image) I of the subject J captured in actual space has different position coordinates in the three images SI1, SI2, SI3 because of a shake of the digital camera 1 in image capture. In FIG. 37, the subject images I in the images SI1, SI2, SI3 are aligned so that the images SI1, SI2, and SI3 are misaligned. In FIG. 38, the frames (not shown) of the three images SI1, SI2, and SI3 are aligned so that the subject images I in the images SI1, SI2, and SI3 are misaligned. FIG. 38 also shows a track L1 that the subject images I in the images SI1, SI2, and SI3 describe because of “camera shake”. That is the movement of the subject image I is shown in FIG. 38, wherein subject images corresponding to the images SI1, SI2, and SI3 are indicated by I1, I2, and I3, respectively.

FIG. 39 is an enlarged view illustrating representative points P1, P2, and P3 of, respectively, the subject images I in the images SI1, SI2, and SI3, and their vicinity. The representative points P1, P2, and P3 are corresponding points representing the same position on the subject in the images SI1, SI2, and SI3.

As shown in FIG. 39, a shake of the digital camera 1 in image capture takes place in the direction of the arrow AR1 along the broken line L1. In other words, the broken line L1 indicates a track of the subject image which is produced by a shake of the digital camera 1 in image capture. Such a track of the subject image can be calculated by appropriate interpolation (linear or spline interpolation) to pass the track through the representative points P1, P2, and P3.

Here movements of a captured image are caused by travel of a subject image with respect to the CCD 32 during exposure, and image degradation due to such image movements is caused by a distribution of a light beam, which is given from a single point on the subject, onto the track of travel of the subject image without the light beam converging to a single point on the CCD 32. This, in other words, means that a pixel at a predetermined position in a target image receives light from a plurality of positions on the track of travel of the subject image. For example, a pixel value at a position P2 in the target image SI2 is obtained by summation of light that has been given during an exposure time Δt from an area R2 (a diagonally-shaded area in FIG. 39) which is defined in the vicinity of the position P2 along the track L1 of the subject image.

As for such degradation of the target image due to camera shake, therefore, a degradation function indicating a degradation characteristic can be expressed as a two-dimensional filter based on point spread. Here, the track L1 of the subject image in the target image SI2 is expressed as a two-dimensional filter of a predetermined size (i.e., 5×5) by using spline interpolation.

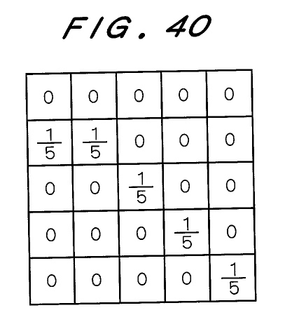

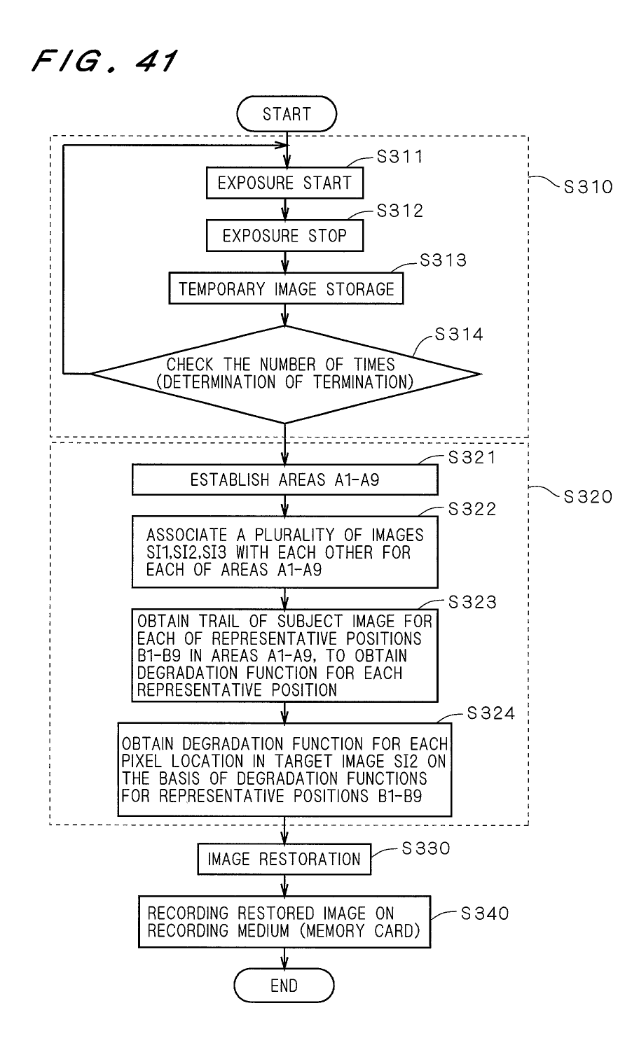

FIG. 40 shows an example of such a two-dimensional filter. It is understood that a pixel at a predetermined position in the target image SI2 is obtained by applying the degradation function, which is expressed as such a two-dimensional filter, to an ideally captured image (hereinafter referred to as an “ideal image”) which suffers no image degradation due to camera shake and the like. This can be expressed by the following equation:

$$q ( i , j ) = {\sum }_{k , 1} \{ w ( k , 1 ) \cdot p ( i + k , j + 1 ) \} \\ ( \begin{matrix}- 2 \leq k \leq + 2 \\ - 2 \leq 1 \leq + 2\end{matrix} ) \qquad ( 4 )$$

where q(i, j) indicates a pixel value with position coordinates (i, j) in the target image SI2; p(i+k, j+1) indicates a pixel value with position coordinates (i+k, j+1) in the ideal image; and w(k, 1) indicates each weighing coefficient in the two-dimensional filter. Referring to the two-dimensional filter of FIG. 40, five positions along the track L1 take on a value of “1/5”, and thus pixel values P corresponding to those five positions each are multiplied by 1/5 and added up, whereby pixel values q are obtained.

As expressed by Equation (4), the pixel value with the predetermined position coordinates (i, j) in the target image SI2 can be expressed by a value which is obtained by weighing pixel values in the vicinity of the position coordinates (i, j) in the ideal image with a predetermined weighing coefficient. Thus, the two-dimensional filter as the above weighing coefficient expresses a track of the subject image in the target image SI2.

Expressed differently, the pixel value with the position coordinates (i, j) in the target image is obtained as the amount of light which has been accumulated during the exposure time Δt at a pixel with the predetermined position coordinates (i, j) in the CCD 32. This amount of light can be obtained by summation of light received from a plurality of positions on a subject along the movement of the subject. That is, the target image SI2 can be considered as an image which is degraded by the application of a degradation function, which is expressed as the above two-dimensional filter, to the “ideal image”.

The above degradation function is for use with the predetermined position coordinates (i, j), but more simply, the same two-dimensional filter may be used as a degradation function for all positions, assuming that such degradation occurs at all the positions. Further, degradation may be expressed in more detail by obtaining the above two-dimensional filter for every position coordinates in an image. In this fashion, at least one degradation function, which indicates the degradation characteristic of the target image due to a shake of an image capturing device, can be obtained.

With such a degradation function for every pixel, restoration processing can be performed. Examples of techniques that can be used in this restoration processing include: (1) the technique for obtaining a restoration function with assumed boundary conditions; (2) the technique for restoring a specific frequency component; and (3) the technique for updating an assumed image by the iterative method. Those techniques have been discussed above.

Now, the detailed operations of the CCD 32, the degradation-function calculation unit 411, the restoration unit 412, and the like are discussed with reference to FIG. 41.

FIG. 41 is a flow chart of processing. As shown in FIG. 41, the CCD 32 continuously captures a plurality of images SI1, SI2, and SI3 in step S310 and the degradation-function calculation unit 411 obtains a track of a subject image in the target image SI2 from the plurality of images SI1, SI2, and SI3 in step S320. Thereby, at least one degradation function which indicates a degradation characteristic of the target image SI2 due to a shake of the digital camera 1 is obtained. In step S330, the restoration unit 412 restores the target image SI2 by using at least one degradation function obtained in step S320. The followings are more detailed descriptions of the processing of steps S310 to S330.

First, the processing of step S310 is described. In this step, exposures are performed for a predetermined very short time Δt (e.g., ⅙ second) between exposure start (step S311) and exposure stop (step S312), whereby the CCD 32 forms a subject image. The image SI1 formed in this way as digital image signals is then temporarily stored in the RAM 43 (step S313, see FIG. 5). Step S314, which makes a determination of the termination of processing, determines whether or not the same operation (shooting operation) is repeated three times. When the number of times the above shooting operation is carried out is less than three, the process returns to step S311 for another shooting operation to capture an image SI2 or SI3, and then goes to the next step S320 after recognizing a three-time repetition of the shooting operation. Through the processing of step S310, the plurality of continuously captured images SI1, SI2, and SI3 are obtained.

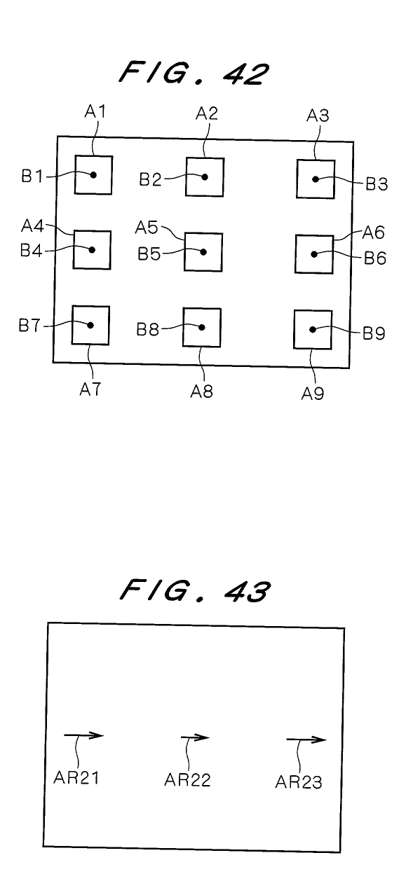

Next, the processing of step S320 is discussed. In this step, a degradation functions for each of a plurality of representative positions (nine representative positions) B1 to B9 (cf. FIG. 42) is obtained and then a degradation function for every position is obtained on the basis of the degradation functions for the representative positions B1 to B9.

First, areas A1 to A9 (cf. FIG. 42) including, respectively, the representative positions B1 to B9 are established in step S321. This establishment of the areas A1 to A9 is made in the target image SI2. With respect to the vertical direction, the areas A1 to A3 are located in the upper portion of the image, the areas A4 to A6 in the middle portion, and the areas A7 to A9 in the lower portion. With respect to the horizontal direction, on the other hand, the areas A1, A4, A7 are located in the left-side portion of the image, the areas A2, A5, A8 in the middle portion, and the areas A3, A6, A9 in the right-side portion. The representative positions B1 to B9 are in the center of the areas A1 to A9, respectively.

In step S322, the plurality of images (three images) SI1, SI2, and SI3 are associated with each other for each of the areas A1 to A9. That is, what position each of the areas A1 to A9 established in the image SI2 takes in the other images SI1 and SI3 is determined. To establish this correspondences, techniques such as matching and a gradient method can be used.

After establishing such image correspondences, a track L1 (cf. FIG. 39) of the subject image in the target image SI2 is obtained in step S323. This track L1 can be obtained for each of the representative positions B1 to B9 in the areas A1 to A9 which were associated in the images SI1, SI2, and SI3. Then, a two-dimensional filter (cf. FIG. 40) is obtained for each of the representative positions B1 to B9 on the basis of the corresponding track L1. These two-dimensional filters are degradation functions for the representative positions B1 to B9.

After the degradation functions for the plurality of representative positions B1 to B9 are obtained, degradation functions for all pixel locations in the target image SI2 are obtained in the next step S324 on the basis of the nine degradation functions for the representative positions B1 to B9. The degradation function for each pixel location can be determined by, for example, reflecting relative positions of each pixel and the representative positions B1 to B9 in the image on the basis of the plurality of degradation functions (nine degradation functions) for the plurality of representative positions (nine representative positions) B1 to B9. This determination may be made by further reflecting shooting information such as an optical focal length and a distance to the subject. In this fashion, a plurality of degradation functions can be obtained in accordance with pixel locations. This provides more detailed degradation functions, which for example can accommodate nonlinear variations according to pixel locations with flexibility.

More specifically, when camera shake occurs in the horizontal direction during image capture and the like using a wide-angle lens as shown in FIG. 43, the amount of camera shake in left/right end portions of an image becomes greater than that in the middle portion because of lens aberration and the like (the lengths of the arrows AR21 to AR23 in FIG. 43 schematically represent the amounts of camera shake at the respective locations). In such a case, independent degradation functions are obtained for respective position coordinates in the X direction (or horizontal direction) in the image. This allows high-precision degradation-function representation, thereby enabling high-precision image restoration. In this fashion, even if degradation functions vary according to position coordinates in the image, the preferred embodiment is applicable on the basis of, for example, differences in optical properties of lenses and the like.

As above described, a degradation function for every pixel location can be calculated on the basis of a plurality of degradation functions (nine degradation functions) calculated for the plurality of areas (nine areas) A1 to A9.

The aforementioned description is given on the premise that each pixel location has a different degradation function, but more simply, as above described, one degradation function obtained for a single representative position may be regarded as a degradation function for all pixel positions.

In step S330, restoration processing is performed with the degradation functions obtained in step S320. This restoration processing may adopt any of the image restoration methods shown in FIGS. 12 to 14 or it may adopt any other method.

In step S340, a restored image obtained in step S330 is recorded on a recording medium such as a memory card using a semiconductor memory. The recording medium may be any medium other than a memory card, e.g., it may be a magnetic disk or an optical magnetic disk.

While in the seventh preferred embodiment, the plurality of images SI1, SI2, and SI3 each are captured during the same amount of very short exposure time Δt, this embodiment is not limited thereto. For example, the exposure time to capture the images SI1 and SI3 before and after the target image SI2 may be shorter than that to capture the target image SI2. In this case, camera shake is reduced and positional accuracy is improved in the images SI1 and SI3; therefore, a more accurate track L1 of the subject image can be obtained in the above step S320. That is, more proper restoration of the target image SI2 is made possible by ensuring a sufficient amount of exposure time for the target image SI2 while shortening the exposure time for the images SI1 and SI3 before and after the target image SI2.

While in the seventh preferred embodiment, the plurality of images SI1, SI2, and SI3 each include the same number of pixels; for example, the numbers of pixels in the images SI1 and SI3 before and after the target image SI2 may be smaller than that in the target image SI2 (i.e., the images SI1 and SI3 may appear jagged). Even in this case, the track L1 of the subject image ensures a predetermined level of positional accuracy.

As above described, the target image SI2 to be restored and the other images SI1, SI3 may be captured under different shooting conditions (exposure time, pixel resolution, etc.) For example, the images SI1 and SI3 may be live view images. Here the “live view image” refers to an image that is displayed in real time on a display monitor on the back of the digital camera.

While in the seventh preferred embodiment, the two-dimensional filters are 5×5 in size, they may be of any other size (3×3, 7×7, etc.). Further, the two-dimensional filters are not necessarily the same in size but may be of different sizes for a proper representation of the track at each pixel location.

While in the seventh preferred embodiment, three continuously captured images are used to obtain degradation functions, for example, with two continuously captured images, the above track L1 may be obtained by interpolation between two points and estimation of subsequent travel of the track. As another alternative, N (≧4) continuously captured images may be used. In this case, the aforementioned operations (calculation of degradation functions and restoration) should be performed on each of (N− 2) images as a target image, excluding the first and the last images (a total of two images). At this time, if a track to connect N (≧4) points is obtained by spline interpolation or the like, a more accurate track of the subject image can be obtained. Further, averaging or the like with the (N−2) restored images obtained allows a further reduction in the influence of noise. In this case, averaging of pixels should preferably be carried out after images are associated with each other in consideration of the amount of travel in each image due to camera shake or the like in image capture.

While in the seventh preferred embodiment, the images SI1 and SI3 for modification are captured separately before and after the target image SI2, they may be replaced by live view images.

While the digital image capturing devices described in the seventh preferred embodiment are for capturing still images, they may be devices for capturing dynamic images. That is, the aforementioned processing is also applicable to digital image capturing devices for capturing dynamic images, in which case, in obtaining a still image from a dynamic image, a target image due to camera shake or the like in image capture can be restored with high precision without the use of any specific shake sensor. For example, degradation of a dynamic image, which is comprised of a plurality of continuously captured frame images, can be restored by using at least one of the plurality of frame images as a target image. From this, even with degradation of a dynamic image due to camera shake in image capture, the aforementioned processing can achieve the same effect.

The aforementioned restoration processing is also applicable in a case where, in obtaining a still image from a dynamic image, not a shake of a digital image capturing device but a movement of a subject itself causes image degradation in accordance with a track of the subject image in a target image as above described. For example, when only part of dynamic images is degraded by the “movement” of the subject itself, a desirable still image can be obtained by performing the aforementioned processing only on that part of the dynamic images which suffers the “movement”.

While in the seventh preferred embodiment, image capture of a plurality of images and image restoration are performed as a sequence of operations and restored images obtained are stored in a recording medium; for example, with a recording medium or the like storing a plurality of captured images (before-restoration images) and degradation functions at predetermined positions, restoration processing on a target image may be performed separately after the completion of a sequence of shooting operations. Or, with a recording medium or the like storing only a plurality of captured images (before-restoration images), the calculation of degradation functions and the image restoration may be performed separately. In those cases, even if the calculation of degradation functions and/or the image restoration require enormous amounts of time, the length of time until the completion of image storage can be shortened. This reduces the load of processing during image capture on the CPU in the digital camera 1, thereby enabling higher-speed continues shooting operations and the like.

The aforementioned operations (calculation of degradation functions and image restoration) are not necessarily performed in a digital image capturing device such as the digital camera 1. Instead, a computer system may be used to perform similar operations on the basis of a plurality of images continuously captured by such a digital image capturing device.

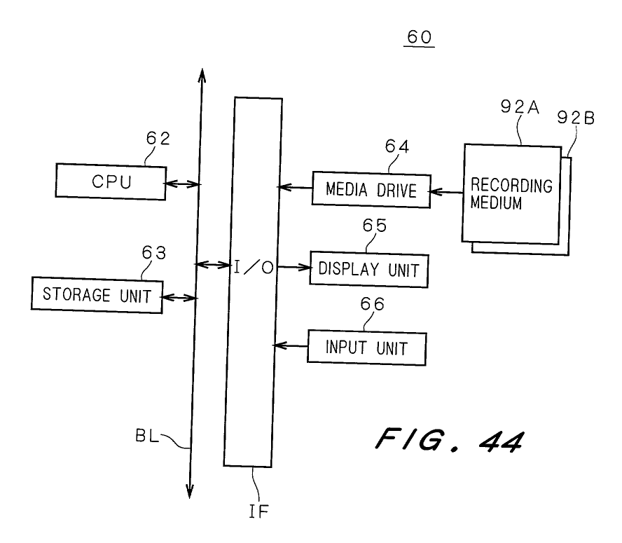

FIG. 44 is a schematic diagram of a hardware configuration of such a computer system (hereinafter referred to simply as a “computer”). A computer 60 comprises a CPU 62, a storage unit 63 including a semiconductor memory, a hard disk, and the like, a media drive 64 for fetching information from a variety of recording media, a display unit 65 including a monitor and the like, and an input unit 66 including a keyboard, a mouse, and the like.

The CPU 62 is connected through a bus line BL and an input/output interface IF to the storage unit 63, the media drive 64, the display unit 65, the input unit 66, and the like. The media drive 64 fetches information which is recorded on a transportable recording medium such as a memory card, a CD-ROM, a DVD (digital versatile disk), and a flexible disk.

The computer 60 loads a program from a recording medium 92A for recording the program, thereby to have a variety of functions such as the aforementioned degradation-function calculating and restoring functions. A plurality of images continuously captured by a digital image capturing device such as the digital camera 1 are loaded in this computer 60 via a recording medium 92B such as a memory card.

The computer 60 then performs the aforementioned calculation of degradation functions and restoration of a target image, thereby achieving the same functions as above described.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus comprising:
an obtaining section for obtaining image data generated by converting an optical image passing through an optical system into digital data; and
a processing section for applying a degradation function based on a degradation characteristic of at least one optical element comprised in said optical system to said image data and restoring said image data by compensating for a degradation thereof.

2. The image processing apparatus according to claim 1, wherein
said degradation function depends on a position of each pixel.

3. The image processing apparatus according to claim 1, wherein
said degradation function is based on a focal length, an in-focus lens position and an aperture value.

4. The image processing apparatus according to claim 3, wherein
said degradation function is generated from conditions of a lens system and a diaphragm in said optical system.

5. The image processing apparatus according to claim 1, wherein
said degradation function corresponds to a plurality of pixels.

6. The image processing apparatus according to claim 1, wherein
said processing section processes part of said image data, said part of said image data being determined on the basis of a difference between a pixel value of each pixel and pixel values of pixels adjacent to said each pixel.

7. The image processing apparatus according to claim 1, wherein
said processing section processes part of said image data, said part of said image data being determined on the basis of said degradation function.

8. The image processing apparatus according to claim 1, wherein
said processing section processes part of said image data, said part of said image data being determined on the basis of pixel values in said image data.

9. An image pick-up apparatus comprising:
a generating section for generating image data by converting an optical image passing through an optical system into digital data; and
an outputting section for outputting said image data out of said apparatus together with information for restoring said image data, said information including a degradation function based on a degradation characteristic of at least one optical element comprised in said optical system.

10. An image processing apparatus comprising:
a receiving section for receiving a plurality of image data sets generated by two or more consecutive image captures;
a calculating section for calculating a degradation function on the basis of a difference between said plurality of image data sets; and
a restoring section for restoring one of said plurality of image data sets by applying said degradation function.

11. The image processing apparatus according to claim 10, wherein
said one of said plurality of image data sets is restored without a sensor which detects a shake of an image capturing device.

12. The image processing apparatus according to claim 10, wherein
said degradation function is generated as a two-dimensional filter on the basis of a track of a subject on images of said plurality of image data sets.

13. The image processing apparatus according to claim 10, wherein
said degradation function is generated for each of representative positions on one of images of said plurality of image data sets.

14. The image processing apparatus according to claim 10, wherein
any other image data set than said one of said plurality of image data sets is generated by a shorter-time image capture than said one of said plurality of image data sets.

15. The image processing apparatus according to claim 10, wherein
any other image than an image of said one of said plurality of image data sets has less pixels than said image of said one of said plurality of image data sets.

16. The image processing apparatus according to claim 10, wherein
any other image than an image of said one of said plurality of image data sets is a live view image.

17. An image pick-up apparatus comprising:
a generating section for generating a plurality of image data sets generated by two or more consecutive image pick-upping;
a calculating section for calculating a degradation function on the basis of a difference between said plurality of image data sets to restore one of said plurality of image data sets; and
an outputting section for outputting said one of said plurality of image data sets out of said apparatus together with said degradation function so as to restore said one of said plurality of image data sets with said degradation function.

18. The image pick-up apparatus according to claim 17, wherein
said image pick-up apparatus is portable.

19. An image processing apparatus comprising:
a setting section for setting partial areas in a whole image, said partial areas being delimited according to contrast in said whole image; and
a modulating section for modulating images comprised in said partial areas on the basis of a degradation characteristic of said whole image to restore said whole image.

20. An image processing apparatus comprising:
a setting section for setting partial areas in a whole image on the basis of at least one degradation characteristic of said whole image; and
a modulating section for modulating images comprised in said partial areas on the basis of said at least one degradation characteristic to restore said whole image.

21. The image processing apparatus according to claim 20, wherein
said at least one degradation characteristic is derived from a shake of an image capturing device, said whole image being captured by said image capturing device.

22. An image processing apparatus comprising:
a setting section for setting partial areas in a whole image on the basis of a distribution of pixel values in said whole image; and
a modulating section for modulating images comprised in said partial areas on the basis of a degradation characteristic of said whole image to restore said whole image.

23. The image processing apparatus according to claim 22, wherein
said setting section sets said partial areas on the basis of a distribution of brightness in said whole image.

24. An image processing apparatus comprising:
a setting section for setting areas to be modulated in a whole image;
a restoring section for restoring said whole image by modulating images in said areas in accordance with a specified function; and
an altering section for altering sizes of said areas in accordance with a restored whole image, wherein
said restoring section again restores said whole image by modulating images in said areas whose sizes are altered by said altering section in accordance with said specified function.

25. The image processing apparatus according to claim 24, wherein
said setting section sets said areas according to contrast in said whole image.

26. The image processing apparatus according to claim 24, wherein
said setting section sets said areas on the basis of at least one degradation characteristic of said whole image.

27. The image processing apparatus according to claim 24, wherein
said setting section sets said areas on the basis of a distribution of pixel values in said whole image.

28. The image processing apparatus according to claim 24, wherein
said altering section alters said sizes of said areas in accordance with a distribution of pixel values around areas not to be modulated.
